(19) United States
(12) Patent Application Publication
(10) Pub. No.: US 2024/0182054 A1
(43) Pub. Date: Jun. 6, 2024

(54) DRIVING ASSISTANCE INFORMATION GENERATION APPARATUS, DRIVING ASSISTANCE APPARATUS, AND DRIVING ASSISTANCE INFORMATION GENERATION METHOD

(71) Applicant: Mitsubishi Electric Corporation, Tokyo (JP)

(72) Inventors: Yoshinori UENO, Tokyo (JP); Mitsuo SHIMOTANI, Tokyo (JP); Yusuke ARAI, Tokyo (JP)

(73) Assignee: Mitsubishi Electric Corporation, Tokyo (JP)

(21) Appl. No.: 18/282,945

(22) PCT Filed: May 19, 2021
(86) PCT No.: PCT/JP2021/018918

§ 371 Date: Sep. 19, 2023

(51) Int. Cl. B60W 50/14; B60W 40/06; B60W 40/08; G01C 21/36; H04W 4/46

(52) U.S. Cl. CPC B60W 50/14; B60W 40/06; B60W 40/08; G01C 21/3617; G01C 21/3632; H04W 4/46; B60W 2050/143; B60W 2050/146; B60W 2540/043; B60W 2540/22; B60W 2540/221; B60W 2556/10; B60W 2556/40; B60W 2556/50; B60W 2556/65

(57) ABSTRACT

Provided is a driving assistance information generation apparatus that can cause a vehicle to travel so that an abnormality does not occur in a condition of an occupant other than a driver. The driving assistance information generation apparatus includes processing circuitry to: collect occupant condition information of an occupant, other than a driver, of a vehicle being an information collection source, and position information of the vehicle; determine a caution point where an abnormality has occurred in the condition of the occupant, based on the occupant condition information and the position information; store information of the caution point; and output the information of the caution point to a target vehicle being an information providing destination, based on a request from outside. The occupant condition information includes information related to a condition of at least one of a physical condition, a physiological condition, and a mental condition of the occupant.

### TECHNICAL FIELD

The present disclosure relates to a driving assistance information generation apparatus, a driving assistance apparatus, and a driving assistance information generation method.

### BACKGROUND ART

In order to assist smooth movement of a vehicle, a navigation apparatus that issues a warning in approach to a dangerous place has been developed.

For example, a driving assistance apparatus described in Patent Document 1 stores a hazard map recording places where biometric information of drivers change from a normal condition. When a vehicle is located in a place recorded in the hazard map, the driving assistance apparatus issues a warning to caution the driver, based on biometric information of the driver.

### PRIOR ART DOCUMENT

### Patent Document

Patent Document 1: Japanese Patent Application Laid-Open No. 2011-242190

### SUMMARY

### Problem to be Solved by the Invention

With a method of issuing a warning based on the biometric information of the driver, driving assistance in consideration of the condition of the driver can be performed, but driving assistance in consideration of the condition of an occupant other than the driver cannot be performed. Depending on a driving operation, the occupant other than the driver may fall into an unstable condition or an uncomfortable condition.

In order to solve the problem described above, the present disclosure provides a driving assistance information generation apparatus that can cause a vehicle to travel so that an abnormality does not occur in a condition of an occupant other than a driver.

### Means to Solve the Problem

A driving assistance information generation apparatus according to the present disclosure includes an information collection unit, an abnormality determination unit, a storage, and an information output unit. The information collection unit is to collect occupant condition information of an occupant, other than a driver, of a vehicle being an information collection source, and position information of the vehicle. The occupant condition information includes information related to a condition of at least one of a physical condition, a physiological condition, and a mental condition of the occupant of the vehicle other than the driver. The abnormality determination unit is to determine a caution point being a point where an abnormality has occurred in the condition of the occupant, based on the occupant condition information and the position information. The storage is to store information of the caution point. The information output unit is to output the information of the caution point where the abnormality has previously occurred in the condition of the occupant to a target vehicle being an information providing destination, based on a request from outside.

### Effects of the Invention

According to the driving assistance information generation apparatus of the present disclosure, a vehicle can be caused to travel so that an abnormality does not occur in a condition of an occupant other than a driver.

These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a functional block diagram illustrating a configuration of a driving assistance information distribution system according to a first embodiment.

FIG. 2 is diagram illustrating an example of a configuration of processing circuitry included in a driving assistance information generation apparatus.

FIG. 3 is a diagram illustrating another example of a configuration of processing circuitry included in the driving assistance information generation apparatus.

FIG. 4 is a flowchart illustrating a method of acquiring occupant-related information according to the first embodiment.

FIG. 5 is a flowchart illustrating a method of storing information of caution points according to the first embodiment.

FIG. 6 is a diagram illustrating specific examples of the caution points.

FIG. 7 is a flowchart illustrating a method of providing the information of the caution points according to the first embodiment.

FIG. 8 is a functional block diagram illustrating a configuration of a driving assistance information distribution system according to a first modification of the first embodiment.

FIG. 9 is a flowchart illustrating a driving assistance information generation method according to the first modification of the first embodiment.

FIG. 10 is a functional block diagram illustrating a configuration of a driving assistance information distribution system according to a second modification of the first embodiment.

FIG. 11 is a functional block diagram illustrating a configuration of a driving assistance information distribution system according to a sixth modification of the first embodiment.

FIG. 12 is a functional block diagram illustrating a configuration of a driving assistance information distribution system according to a seventh modification of the first embodiment.

FIG. 13 is a functional block diagram illustrating a configuration of a driving assistance information distribution system according to a ninth modification of the first embodiment.

FIG. 14 is a functional block diagram illustrating a configuration of a driving assistance information distribution system according to a second embodiment.

FIG. 15 is a flowchart illustrating a driving assistance method according to the second embodiment.

FIG. 16 is a diagram illustrating a notification example of the information of the caution points and reassurance driving information.

FIG. 17 is a functional block diagram illustrating a configuration of a driving assistance information distribution system according to a third modification of the second embodiment.

FIG. 18 is a functional block diagram illustrating a configuration of a driving assistance information distribution system according to a fourth modification of the second embodiment.

FIG. 19 is a diagram illustrating an example of a route having a small number of points to be paid attention to.

FIG. 20 is a diagram illustrating an example of a route on which aid from a medical institution can be promptly received.

FIG. 21 is a functional block diagram illustrating a configuration of a driving assistance information distribution system according to a sixth modification of the second embodiment.

FIG. 22 is a functional block diagram illustrating a configuration of a driving assistance information distribution system according to a seventh modification of the second embodiment.

FIG. 23 is a functional block diagram illustrating a configuration of a driving assistance information generation apparatus and a driving assistance apparatus according to a third embodiment.

### DESCRIPTION OF EMBODIMENTS

### First Embodiment

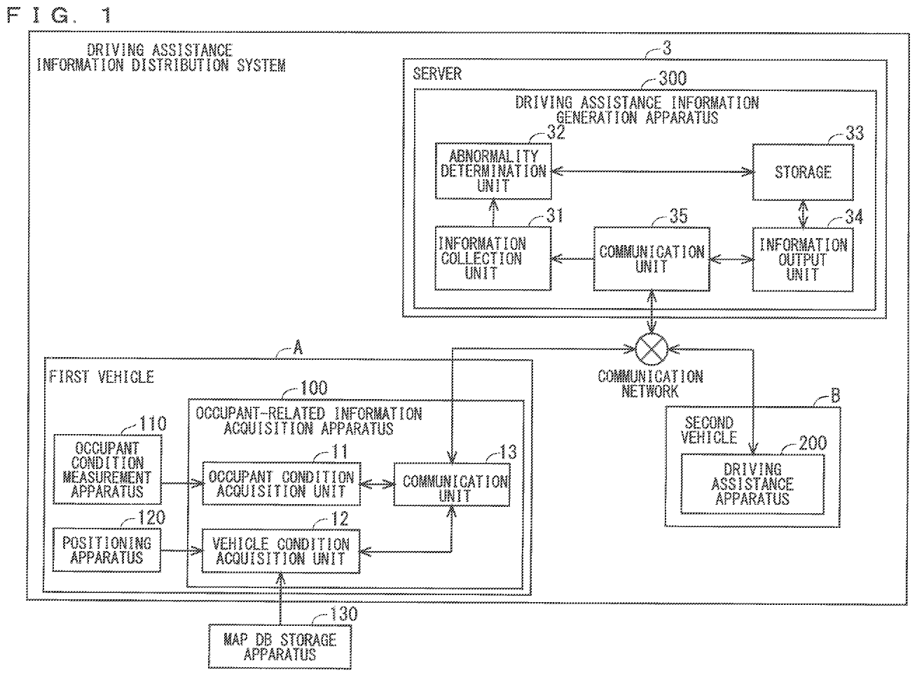

FIG. 1 is a functional block diagram illustrating a configuration of a driving assistance information distribution system according to a first embodiment.

The driving assistance information distribution system includes an occupant-related information acquisition apparatus 100, a driving assistance apparatus 200, a driving assistance information generation apparatus 300, an occupant condition measurement apparatus 110, a positioning apparatus 120, and a map database (map DB) storage apparatus 130. The driving assistance information generation apparatus 300 is provided in a server 3. The positioning apparatus 120 and the occupant-related information acquisition apparatus 100 are provided in a first vehicle A, which is an information collection source. The occupant condition measurement apparatus 110 may be provided in the first vehicle A, or may be carried by an occupant of the first vehicle A. The map DB storage apparatus 130 may be provided in the server 3, or may be provided in the first vehicle A. The driving assistance apparatus 200 is provided in a second vehicle B, which is an information providing destination. The driving assistance information generation apparatus 300, the occupant-related information acquisition apparatus 100, and the driving assistance apparatus 200 are connected to each other via a communication network.

An occupant of a vehicle hereinafter refers to a person other than a driver, among persons in a vehicle. The occupant is, for example, a person provided with transportation. The occupant is, for example, a person who needs a special attention, such as a person with a disease, a person receiving care, and a preschool student, but is not limited thereto. The occupant of the second vehicle B being an information providing destination is hereinafter referred to as a target occupant, and is distinguished from the occupant of the first vehicle A being an information collection source.

### (Occupant Condition Measurement Apparatus)

The occupant condition measurement apparatus 110 detects a condition of at least one of a physical condition, a physiological condition, and a mental condition of the occupant of the first vehicle A other than the driver. The physical condition includes a posture or a motion, and is, for example, a degree of rocking of the body, a degree of deviation from a seat, or the like. The physiological condition is, for example, a blood pressure reading, a heart rate, a respiratory rate, or the like. The mental condition is a degree of fear perceived by the occupant, a degree of discomfort, a degree of dizziness, or the like. The occupant condition measurement apparatus 110 may detect a facial expression of the occupant as the physical condition or the mental condition. The conditions of the occupant are not limited to these.

The occupant condition measurement apparatus 110 is, for example, a mm Wave sensor, a seating sensor, or the like. The mmWave sensor measures respiration of the occupant. The seating sensor measures a seated position of the occupant. The occupant condition measurement apparatus 110 includes a camera and an image recognition apparatus, for example. The image recognition apparatus performs image processing on an image captured by the camera, and recognizes, i.e., detects, a facial expression of the occupant. The occupant condition measurement apparatus 110 may be a wearable device that measures physiological information of the occupant. The wearable device includes an infrared sensor, for example, and measures a blood flow of the occupant. The occupant condition measurement apparatus 110 may be a system combining these sensors and apparatuses.

### (Positioning Apparatus)

The positioning apparatus 120 detects a position of the first vehicle A. The positioning apparatus 120 includes a global navigation satellite system (GNSS) receiver, a vehicle sensor, or the like, for example. The vehicle sensor is a speed sensor, an acceleration sensor, or the like, for example. The positioning apparatus 120 receives positioning data via the GNSS receiver, and detects the position of the first vehicle A, for example. The positioning apparatus 120 may acquire map data from the map DB storage apparatus 130, and execute map matching. The positioning apparatus 120 may acquire sensor information acquired by various vehicle sensors, and correct position information of the first vehicle A.

### (Occupant-Related Information Acquisition Apparatus)

The occupant-related information acquisition apparatus 100 includes an occupant condition acquisition unit 11, a vehicle condition acquisition unit 12, and a communication unit 13.

The occupant condition acquisition unit 11 acquires occupant condition information being information related to the condition of the occupant of the first vehicle A from the occupant condition measurement apparatus 110. The occupant condition information includes information related to the condition of at least one of the physical condition, the physiological condition, and the mental condition detected by the occupant condition measurement apparatus 110.

The vehicle condition acquisition unit 12 acquires the position information of the first vehicle A from the positioning apparatus 120. The vehicle condition acquisition unit 12 may acquire map data related to traveling of the first vehicle from the map DB storage apparatus 130.

The communication unit 13 is connected to the driving assistance information generation apparatus 300 via the communication network. The communication unit 13 uploads the occupant condition information and the position information of the first vehicle A to the driving assistance information generation apparatus 300. The information uploaded from the first vehicle A to the driving assistance information generation apparatus 300 is hereinafter referred to as occupant-related information. Here, the occupant-related information includes the occupant condition information and the position information of the first vehicle A. The communication unit 13 may upload the occupant-related information in real time, or may upload information stored in a certain period of time.

In uploading, the occupant-related information acquisition apparatus 100 may perform degeneration processing on the occupant-related information, and thereby reduce the volume of data. For example, the occupant-related information acquisition apparatus 100 degenerates waveform data of a heart included in the occupant condition information into statistic data related to a heart rate. The occupant-related information acquisition apparatus 100 may classify image data of the occupant included in the occupant condition information into facial expressions of the occupant, such as pleasure, anger, sorrow, and joy and no emotions, and thereby reduce the volume of data.

### (Driving Assistance Information Generation Apparatus)

The driving assistance information generation apparatus 300 includes an information collection unit 31, an abnormality determination unit 32, a storage 33, an information output unit 34, and a communication unit 35.

The information collection unit 31 sequentially collects the occupant condition information and the position information of the first vehicle A.

The abnormality determination unit 32 determines a caution point, which is a point where an abnormality occurs in the condition of the occupant, based on the occupant condition information and the position information. In this case, the abnormality determination unit 32 determines whether or not the condition of the occupant is abnormal, based on the occupant condition information and a predetermined determination rule related to the condition of the occupant.

For example, when an inclination of the body is a predetermined inclination or greater, the abnormality determination unit 32 determines that an abnormality occurs in the condition of the occupant. When the occupant has fallen off the seated position, or when the occupant is bending forward, the abnormality determination unit 32 determines that the condition is abnormal.

For example, when rocking of the body exceeds a predetermined range of rocking, the abnormality determination unit 32 determines that an abnormality occurs in the condition of the occupant. When the occupant wobbles, the abnormality determination unit 32 determines that the condition is abnormal.

For example, when a facial expression, a heart rate, a pulse rate, a degree of respiration, a complexion, or the like becomes worse than a predetermined degree, the abnormality determination unit 32 determines that an abnormality occurs in the condition of the occupant. When the occupant feels sick or nervous, the abnormality determination unit 32 determines that the condition is abnormal.

The abnormality determination unit 32 may determine that an abnormality occurs in the condition of the occupant, when the current condition of the occupant has become worse than a predetermined degree, compared to the condition of the occupant when the occupant gets in the first vehicle A.

The storage 33 stores information of the caution points. The storage 33 stores the information of the caution points where abnormalities have previously occurred in conditions of occupants by the abnormality determination unit 32. In the stored information of the caution points, one caution point need not be a point where a plurality of abnormalities have occurred in the same occupant. In other words, one caution point may be a point where an abnormality has occurred in each of a plurality of occupants. The information of the caution points may be a hazard map, a database of minor incidents, or the like. The hazard map is map data storing position information of the caution points. The storage 33 may store the time and the day of the week when the condition of the occupant is determined to be abnormal, in association with the information of the caution points.

The information output unit 34 outputs the information of the caution points to the second vehicle B via the communication unit 35, based on a request for information provision from outside. The outside is, for example, the driving assistance apparatus 200 of the second vehicle B, but is not limited thereto. The outside is a center that distributes traffic information, a center that manages a traveling condition of the second vehicle B, a center that implements remote automated driving of the second vehicle B, or the like. The information of the caution points is included in the driving assistance information.

The communication unit 35 is connected to the occupant-related information acquisition apparatus 100 of the first vehicle A and the driving assistance apparatus 200 of the second vehicle B via the communication network. The communication unit 35 receives the occupant condition information and the position information from the occupant-related information acquisition apparatus 100 of the first vehicle A. The communication unit 35 receives a request for information provision from the outside. The communication unit 35 transmits the information of the caution points to the driving assistance apparatus 200 of the second vehicle B.

### (Driving Assistance Apparatus)

The driving assistance apparatus 200 acquires the information of the caution points. The driving assistance apparatus 200 controls a notification apparatus (not illustrated) provided in the second vehicle B so as to give notification of the information of the caution points, based on a positional relationship between the position of the second vehicle B and the caution points.

### (Configuration of Processing Circuitry)

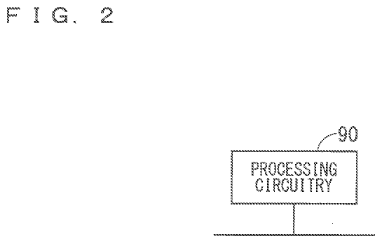

FIG. 2 is a diagram illustrating an example of a configuration of processing circuitry 90 included in the driving assistance information generation apparatus 300. The functions of the information collection unit 31, the abnormality determination unit 32, the storage 33, the information output unit 34, and the communication unit 35 are implemented by the processing circuitry 90. In other words, the processing circuitry 90 includes the information collection unit 31, the abnormality determination unit 32, the storage 33, the information output unit 34, and the communication unit 35.

When the processing circuitry 90 is dedicated hardware, the processing circuitry 90 is, for example, a single circuit, a composite circuit, a programmed processor, a parallel programmed processor, an application specific integrated circuit (ASIC), a field-programmable gate array (FPGA), a circuit combining these, or the like. The functions of the information collection unit 31, the abnormality determination unit 32, the storage 33, the information output unit 34, and the communication unit 35 may be individually implemented by a plurality of processing circuitry, or may be collectively implemented by one processing circuitry.

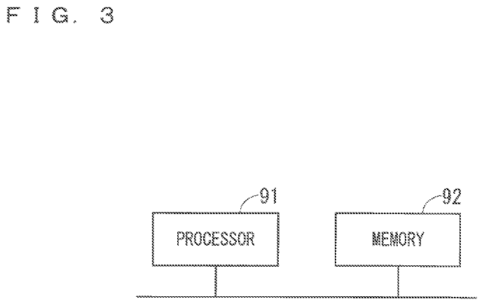

FIG. 3 is a diagram illustrating another example of a configuration of processing circuitry included in the driving assistance information generation apparatus 300. The processing circuitry includes a processor 91 and a memory 92. When the processor 91 executes a program stored in the memory 92, the functions of the information collection unit 31, the abnormality determination unit 32, the storage 33, the information output unit 34, and the communication unit 35 are implemented. For example, when software described as a program is executed by the processor 91, the functions are implemented. In this manner, the driving assistance information generation apparatus 300 includes the memory 92 that stores a program and the processor 91 that executes the program.

The program describes a function of the driving assistance information generation apparatus 300 to collect the occupant condition information of the occupant, other than the driver, of the first vehicle A being an information collection source, and the position information of the first vehicle A. The occupant condition information includes information related to the condition of at least one of the physical condition, the physiological condition, and the mental condition of the occupant of the first vehicle A other than the driver. Further, the program describes a function of the driving assistance information generation apparatus 300 to determine the caution point being a point where an abnormality occurred in the condition of the occupant, based on the occupant condition information and the position information. The program describes a function of the driving assistance information generation apparatus 300 to store the information of the caution points. The program describes a function of the driving assistance information generation apparatus 300 to output the information of the caution points where abnormalities have previously occurred in conditions of occupants to the second vehicle B being an information providing destination, based on a request from the outside. The program is to cause a computer to execute procedures or methods of the information collection unit 31, the abnormality determination unit 32, the storage 33, the information output unit 34, and the communication unit 35.

The processor 91 is a central processing unit (CPU) or the like, for example. The memory 92 is, for example, a non-volatile or volatile semiconductor memory, such as a random access memory (RAM), a read only memory (ROM), a flash memory, an erasable programmable read only memory (EPROM), and an electrically erasable programmable read only memory (EEPROM). Alternatively, the memory 92 may be a storage medium such as a hard disk drive (HDD).

A part of the functions of the information collection unit 31, the abnormality determination unit 32, the storage 33, the information output unit 34, and the communication unit 35 may be implemented by dedicated hardware, and another part thereof may be implemented by software. The processing circuitry implements the functions with a combination of hardware and software.

The occupant-related information acquisition apparatus 100 also includes processing circuitry similar to the processing circuitry illustrated in FIG. 2 or FIG. 3. The functions of the occupant condition acquisition unit 11, the vehicle condition acquisition unit 12, and the communication unit 13 are implemented with the processing circuitry of the occupant-related information acquisition apparatus 100.

### (Method of Acquiring Occupant-Related Information)

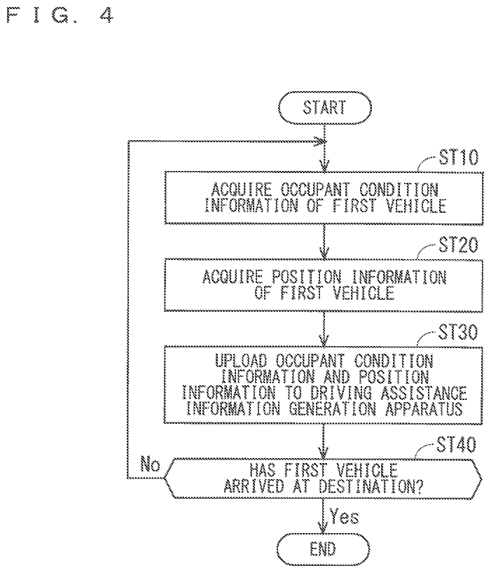

FIG. 4 is a flowchart illustrating a method of acquiring the occupant-related information according to the first embodiment, and illustrates an operation of the occupant-related information acquisition apparatus 100.

In Step ST10, the occupant condition acquisition unit 11 acquires the occupant condition information related to the occupant of the first vehicle A from the occupant condition measurement apparatus 110.

In Step ST20, the vehicle condition acquisition unit 12 acquires the position information of the first vehicle A from the positioning apparatus 120.

In Step ST30, the communication unit 13 uploads the occupant condition information and the position information to the driving assistance information generation apparatus 300. The communication unit 13 may upload the occupant condition information and the position information in real time, or may upload information stored in a certain period of time.

In Step ST40, the occupant-related information acquisition apparatus 100 determines whether or not the first vehicle A has arrived at a destination. If the first vehicle A has not arrived at the destination, Step ST10 is executed again. If the first vehicle A has arrived at the destination, transportation for the occupant has finished, and thus the processing of acquiring the occupant-related information ends.

### (Method of Storing Information of Caution Points)

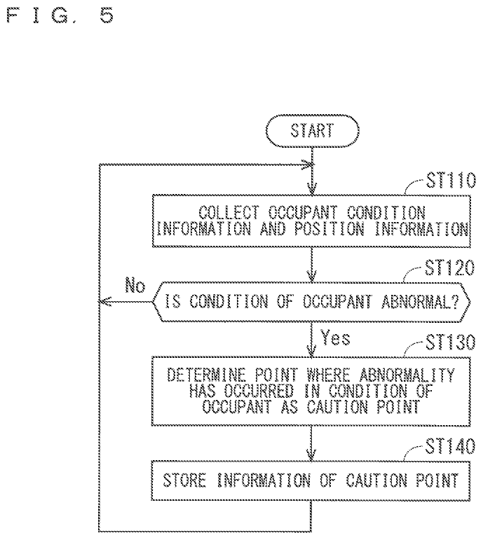

FIG. 5 is a flowchart illustrating a method of storing the information of the caution points according to the first embodiment, and illustrates an operation of the driving assistance information generation apparatus 300.

In Step ST110, the information collection unit 31 collects the occupant condition information and the position information of the first vehicle A via the communication unit 35. The driving assistance information generation apparatus 300 may detect whether or not the occupant condition information and the position information are received, and if those pieces of information are received, the driving assistance information generation apparatus 300 may execute Step ST110. If the occupant condition information and the position information are not received, the driving assistance information generation apparatus 300 repeats the processing of detecting whether or not those pieces of information are received.

In Step ST120, the abnormality determination unit 32 determines whether or not the condition of the occupant is abnormal, based on the occupant condition information and the predetermined determination rule related to the condition of the occupant. When the condition of the occupant is abnormal, Step ST130 is executed. When the condition of the occupant is normal, Step ST110 is executed again.

In Step ST130, the abnormality determination unit 32 determines a point where an abnormality has occurred in the condition of the occupant as the caution point.

In Step ST140, the storage 33 stores the information of the caution points. Subsequently, Step ST110 is executed again. Steps ST110 to ST140 are repeated, and the information of the caution points is stored over a certain period of time. The storage 33 may store a hazard map storing the position information of the caution points in its map data.

### Specific Example of Caution Points

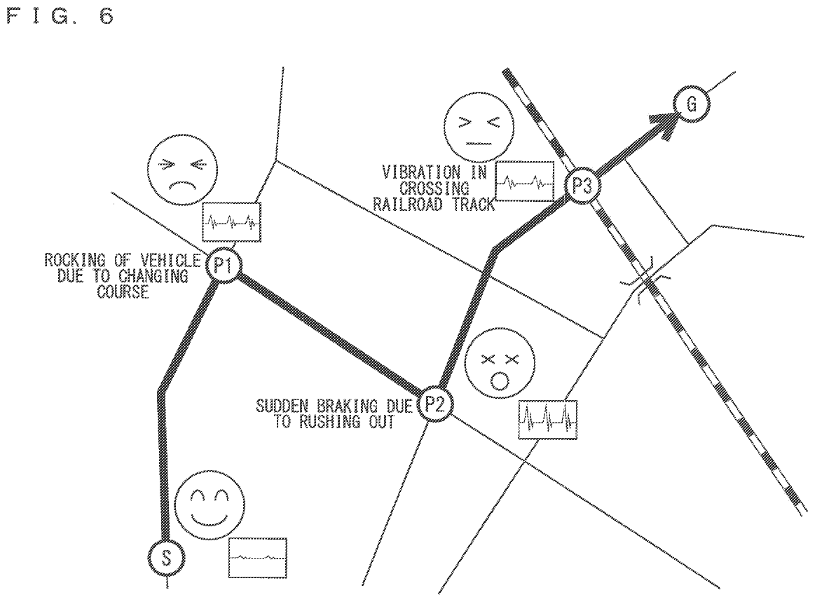

FIG. 6 is a diagram illustrating specific examples of the caution points. Each illustration of a human face is depicted with a typical facial expression so as to allow for imagination of the condition of the occupant in the first vehicle A. The illustration does not depict the facial expression itself of the occupant. Each illustration of a waveform schematically represents a change in the heartbeat of the occupant. The waveform of the change in the heartbeat represents stability of the rate of heartbeat (that is, the heart rate) and the heartbeat. The first vehicle A moves from a starting point S to a destination G. Here, a navigation system suggests the shortest route indicated by the arrow, and the first vehicle A travels along the route. On the route, there are three points P1, P2, and P3 where the condition of the occupant changes from a normal condition to an abnormal condition.

The following description will take an example in which traffic rules for vehicles such as automobiles adopt left-hand traffic, as in the traffic rules of Japan. When traffic rules for vehicles adopt right-hand traffic, right and left positional relationships in a right turn and a left turn, for example, are interchanged.

The point P1 is an intersection. The first vehicle A makes a right turn at the intersection of the point P1. In that case, the first vehicle A changes a lane, deaccelerates, and moves to near the center of the intersection. The first vehicle A stops to wait for an intermission of oncoming vehicles traveling straight. Subsequently, at timing when there is an intermission of oncoming vehicles, the first vehicle A starts, and accelerates and makes a right turn. There is no time when the absence of oncoming vehicles is guaranteed at an intersection where a traffic light dedicated to right-turn vehicles is not installed. This may frequently cause a situation in which the first vehicle A cannot make a right turn until right before the traffic light turns red. The first vehicle A may be required to perform traveling different from usual traveling, and due to the series of movement of the first vehicle A, the occupant is subjected to up and down rocking and back and forth and right and left forces different from those in a steady condition. Such rocking and forces cause rocking of the body and the like of the occupant, and affect the body condition of the occupant. When there is heavy traffic at the intersection, the occupant may feel anxious, which increases a mental load. In FIG. 6, the illustration of the change in the heartbeat at the point P1 represents the condition of the occupant with an increased heart rate.

The point P2 is an intersection. The first vehicle A makes a left turn at the intersection of the point P2. In that case, the first vehicle A deaccelerates and moves to before a crosswalk. The first vehicle A stops to let bicycles or pedestrians crossing the crosswalk go first. At timing when there are no crossing bicycles or pedestrians, or at timing when crossing bicycles or pedestrians have finished crossing, the first vehicle A starts and travels through the crosswalk. Alternatively, in making a left turn, when a bicycle or a motorcycle approaches from behind the first vehicle A on the left side, the first vehicle A stops to let the bicycle or the motorcycle go first. After the bicycle or the motorcycle has passed, the first vehicle A starts and makes a left turn. In some cases, a harder braking operation than usual is required, and rocking and forces caused due to the series of movement of the first vehicle A affect the body condition of the occupant. When there is heavy traffic at the intersection, a mental load of the occupant increases. In FIG. 6, the illustration of the change in the heartbeat at the point P2 represents the condition of the occupant with an increased heart rate and an unstable heartbeat.

The point P3 is a railroad crossing. The first vehicle A crosses the railroad crossing at the point P3. In that case, due to a level difference or the like between a road surface and a railroad track, the first vehicle A is subjected to up and down vibration. When the occupant is undergoing treatment of a bone fracture, the up and down vibration irritates the injured part to no small extent. When an alarm starts to go off while the first vehicle A is crossing the railroad crossing, the alarm causes the occupant to feel mentally nervous. Further, the alarm also causes the driver to feel mentally nervous. When the driver unconsciously accelerates the first vehicle A, rocking and forces caused due to the series of movement affect the body condition of the occupant. In FIG. 6, the illustration of the change in the heartbeat at the point P3 represents the condition of the occupant with a slightly unstable heartbeat.

The abnormality determination unit 32 determines each point of the point P1 to the point P3 as the caution point, based on the changes in the heart rate and the heartbeat of the occupant. The storage 33 stores information of the point P1 to the point P3.

### (Method of Providing Information of Caution Points)

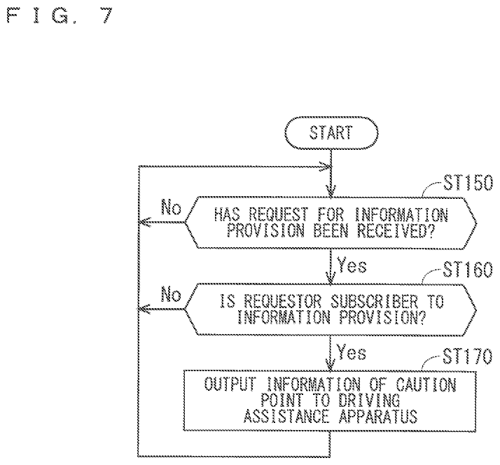

FIG. 7 is a flowchart illustrating a method of providing the information of the caution points according to the first embodiment, and illustrates an operation of the driving assistance information generation apparatus 300.

In Step ST150, the information output unit 34 determines whether or not a request for information provision from the outside has been received via the communication unit 35. If the request for information provision has been received, Step ST160 is executed. If the request for information provision has not been received, Step ST150 is executed again.

In Step ST160, the information output unit 34 determines whether or not a requestor that has requested the information provision is a subscriber to information provision. If the requestor is a subscriber, Step ST170 is executed. If the requestor is not a subscriber, Step ST150 is executed again.

In Step ST170, the information output unit 34 reads the information of the caution points from the storage 33, and outputs the information to the driving assistance apparatus 200 of the second vehicle B. For example, the information output unit 34 outputs a hazard map as the information of the caution points. The driving assistance apparatus 200 controls the notification apparatus so as to give notification of information of the hazard map, based on a positional relationship between the position of the second vehicle B and the caution points. The driver of the second vehicle B performs driving operation based on the hazard map.

To summarize the above, the driving assistance information generation apparatus 300 according to the first embodiment includes the information collection unit 31, the abnormality determination unit 32, the storage 33, and the information output unit 34. The information collection unit 31 is to collect the occupant condition information of the occupant, other than the driver, of the first vehicle A being an information collection source, and the position information of the first vehicle A. The occupant condition information includes information related to the condition of at least one of the physical condition, the physiological condition, and the mental condition of the occupant of the first vehicle A other than the driver. The abnormality determination unit 32 is to determine the caution point being a point where an abnormality has occurred in the condition of the occupant, based on the occupant condition information and the position information. The storage 33 is to store the information of the caution points. The information output unit 34 is to output the information of the caution points where abnormalities have previously occurred in the condition of the occupant to the second vehicle B being an information providing destination, based on a request from outside.

According to the driving assistance information generation apparatus 300 as described above, the driver of the second vehicle B drives in consideration of the information of the caution points. Such driving operation prevents the target occupant of the second vehicle B from falling into an unstable condition or an uncomfortable condition. The target occupant of the second vehicle B can move to the destination, feeling reassured.

In the first embodiment, the occupant-related information acquisition apparatus 100 is provided in the first vehicle A, and the driving assistance apparatus 200 is provided in the second vehicle B. However, the occupant-related information acquisition apparatus 100 and the driving assistance apparatus 200 may be installed in the same vehicle. In other words, the first vehicle A being an information collection source may be the same as the second vehicle B being an information providing destination.

The driving assistance information generation apparatus 300 illustrated in FIG. 1 is connected to the occupant-related information acquisition apparatus 100 installed in one first vehicle A and the driving assistance apparatus 200 installed in one second vehicle B. However, the driving assistance information generation apparatus 300 may be connected to a plurality of occupant-related information acquisition apparatuses 100 respectively installed in a plurality of first vehicles A, and may be connected to a plurality of driving assistance apparatuses 200 respectively installed in a plurality of second vehicles B. In other words, the driving assistance information generation apparatus 300 may be connected to at least one occupant-related information acquisition apparatus 100 and at least one driving assistance apparatus 200 via a communication network. When the driving assistance information generation apparatus 300 is connected to a plurality of occupant-related information acquisition apparatuses 100, the information collection unit 31 collects the occupant condition information and the position information from the plurality of occupant-related information acquisition apparatuses 100. In other words, the information collection unit 31 collects the occupant condition information related to a plurality of occupants and the position information related to a plurality of first vehicles A.

### (First Modification of First Embodiment)

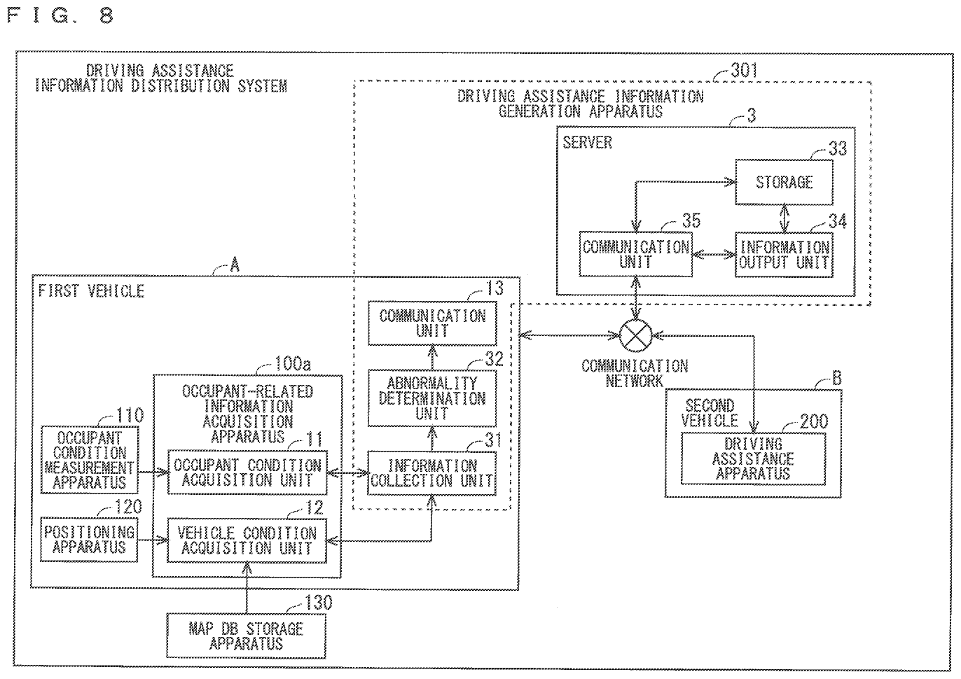

FIG. 8 is a functional block diagram illustrating a configuration of a driving assistance information distribution system according to a first modification of the first embodiment.

In a driving assistance information generation apparatus 301, the information collection unit 31 and the abnormality determination unit 32 are provided in the first vehicle A, and the storage 33, the information output unit 34, and the communication unit 35 are provided in the server 3, similarly to the first embodiment. The function of the driving assistance information generation apparatus 301 is implemented by combining the information collection unit 31, the abnormality determination unit 32, the storage 33, the information output unit 34, and the communication unit 35 mentioned above and the communication unit 13 provided in the first vehicle A. The information collection unit 31 collects the occupant condition information of the first vehicle A from the occupant condition acquisition unit 11 of an occupant-related information acquisition apparatus 100a, and collects the position information from the vehicle condition acquisition unit 12. The abnormality determination unit 32 determines a point where an abnormality has occurred in the condition of the occupant as the caution point. The communication unit 13 uploads information of the caution points to the server 3. The communication unit 35 receives the information of the caution points. The storage 33 stores the information of the caution points. In this manner, the driving assistance information generation apparatus 301 is a driving assistance information generation system including the information collection unit 31, the abnormality determination unit 32, and the communication unit 13 provided in the first vehicle A and the storage 33, the information output unit 34, and the communication unit 35 provided in the server 3. The driving assistance information generation apparatus 301 implements so-called edge computing. Owing to such a configuration, communication traffic volume is reduced, and a load of the processing circuitry of the server 3 is reduced.

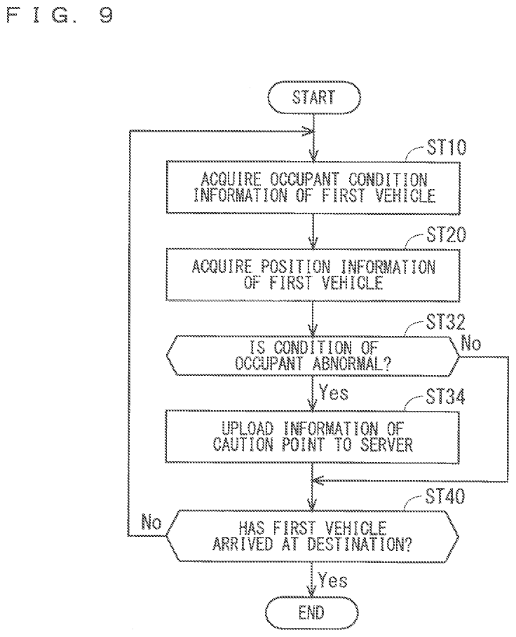

FIG. 9 is a flowchart illustrating a driving assistance information generation method according to the first modification of the first embodiment, and illustrates an operation of the driving assistance information generation apparatus 301 in the first vehicle A. Steps ST10, ST20, and ST40 are similar to those of the method of acquiring the occupant-related information in the first embodiment.

In Step ST10, the occupant condition acquisition unit 11 acquires the occupant condition information related to the occupant of the first vehicle A from the occupant condition measurement apparatus 110.

In Step ST20, the vehicle condition acquisition unit 12 acquires the position information of the first vehicle A from the positioning apparatus 120.

In Step ST32, the information collection unit 31 collects the occupant condition information and the position information of the first vehicle A. The abnormality determination unit 32 determines whether or not the condition of the occupant is abnormal, based on the occupant condition information and the predetermined determination rule related to the condition of the occupant. In this case, the abnormality determination unit 32 may download the determination rule from the server 3 and then execute the determination processing, or may perform processing of synchronizing with the determination rule stored in the server 3 and then execute the determination processing. When the condition of the occupant is abnormal, Step ST34 is executed. When the condition of the occupant is normal, Step ST40 is executed again.

In Step ST34, the abnormality determination unit 32 determines a point where an abnormality has occurred in the condition of the occupant as the caution point. The communication unit 13 uploads information of the caution points to the server 3. The communication unit 13 may upload the information of the caution points in real time, or may upload information stored in a certain period of time. When the storage 33 stores the occupant condition information of the occupant at the occurrence of the abnormality in association with the caution points, the communication unit 13 uploads the occupant condition information in relation to the caution points. The communication unit 35 receives the information of the caution points determined in the first vehicle A, and the storage 33 stores the information of the caution points.

In Step ST40, the occupant-related information acquisition apparatus 100a determines whether or not the first vehicle A has arrived at a destination. If the first vehicle A has not arrived at the destination, Step ST10 is executed again. If the first vehicle A has arrived at the destination, the driving assistance information generation processing ends.

### (Second Modification of First Embodiment)

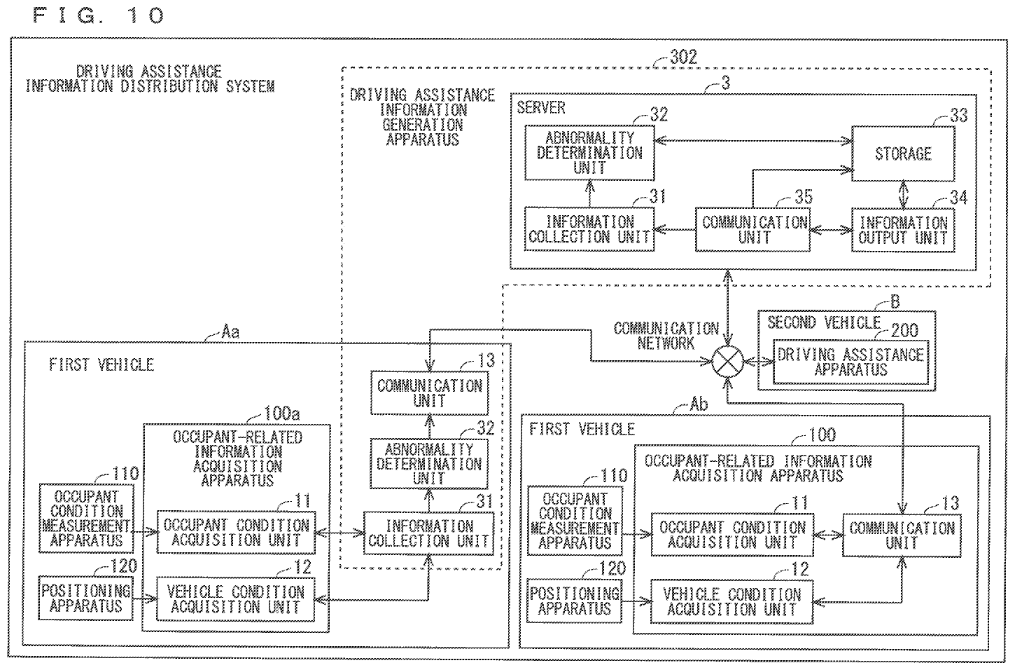

FIG. 10 is a functional block diagram illustrating a configuration of a driving assistance information distribution system according to a second modification of the first embodiment.

The driving assistance information distribution system may include one server 3, at least one first vehicle Aa, and at least one first vehicle Ab. The first vehicle Aa corresponds to the first vehicle A described in the first modification of the first embodiment. The first vehicle Ab corresponds to the first vehicle A described in the first embodiment. In other words, as a plurality of first vehicles A constituting the driving assistance information distribution system, the first vehicle A described in the first embodiment and the first vehicle A described in the first modification of the first embodiment may coexist. In this case, also in the server 3, the information collection unit 31 and the abnormality determination unit 32 are provided. In other words, a driving assistance information generation apparatus 302 includes the information collection unit 31 and the abnormality determination unit 32 provided in the first vehicle Aa, and the information collection unit 31 and the abnormality determination unit 32 provided in the server 3. When the server 3 receives the information of the caution points determined in the first vehicle Aa, the information of the caution points is stored in the storage 33 without the use of the information collection unit 31 and the abnormality determination unit 32 of the server 3. The storage 33 may store information allowing identification as to whether the caution points are the caution points determined in the first vehicle Aa or are the caution points determined in the server 3, in association with the information of the caution points.

Both of the abnormality determination unit 32 of the first vehicle Aa and the abnormality determination unit 32 of the server 3 may determine an abnormality in the condition of the occupant. When both determination results match, the storage 33 may store a determination attribute value indicating that validity of the determination results is “high”, in association with the information of the caution points. When both determination results are different, the storage 33 may store a determination attribute value indicating that validity of the determination results is “low”, in association with the information of the caution points. Depending on the determination attribute value, the driving assistance apparatus 200 of the second vehicle B may change timing of notification and driving assistance or details of notification and driving assistance.

### (Third Modification of First Embodiment)

The storage 33 stores the occupant condition information of the occupants for whom it is determined that an abnormality has occurred at the caution points, in association with the caution points.

The information output unit 34 outputs the occupant condition information associated with the caution points to the second vehicle B, together with the information of the caution points. The occupant condition information includes information related to the condition of at least one of the physical condition, the physiological condition, and the mental condition, similarly to the first embodiment.

The information output unit 34 may output reassurance driving information based on the occupant condition information associated with the caution points to the second vehicle B. The reassurance driving information includes matters to be paid attention to by the driver of the second vehicle B in regard to the driving operation in a caution area including the caution points. The reassurance driving information includes matters to be paid attention to in regard to the driving operation to forestall occurrence of an abnormality in the condition of the target occupant of the second vehicle B, for example. The reassurance driving information includes matters to be paid attention to in regard to operations such as steering, acceleration, and braking of the second vehicle B, for example. The reassurance driving information may include matters to be paid attention to in regard to a lane in which the second vehicle B is to travel in the caution area. The reassurance driving information is included in the driving assistance information, similarly to the information of the caution points.

The driving assistance apparatus 200 controls the notification apparatus. The notification apparatus gives notification of the occupant condition information associated with the caution points, in accordance with the control. In other words, the notification apparatus gives notification of abnormal conditions that are liable to occur in the target occupant at the caution points. The notification apparatus displays the abnormal conditions liable to occur in the target occupant on the hazard map, for example. The notification apparatus may present probabilities of occurrence of abnormalities regarding a degree of rocking of the body, a degree of deviation from a seat, a blood pressure reading, a heart rate, a respiratory rate, a degree of fear perceived by the occupant, a degree of discomfort, a degree of dizziness, and the like. The driver of the second vehicle B performs the driving operation, with knowledge of the abnormalities liable to occur in the target occupant in the caution point.

The driving assistance apparatus 200 may control the notification apparatus so as to display the reassurance driving information at the caution points on the hazard map. The driver of the second vehicle B performs the driving operation, based on the reassurance driving information. Alternatively, the driving assistance apparatus 200 may control an automated driving control apparatus (not illustrated) provided in the second vehicle B. The automated driving control apparatus executes the driving operation based on the reassurance driving information, in accordance with the control. The control for the notification apparatus and the control for the automated driving control apparatus are hereinafter referred to as driving assistance control.

### (Fourth Modification of First Embodiment)

The vehicle condition acquisition unit 12 acquires static information around the first vehicle A as vehicle condition information, based on the position information of the first vehicle A. The static information is an example of the vehicle condition information indicating the condition of the first vehicle A. The vehicle condition information includes, as the static information, road information, construction information, and event information.

The road information is information related to a road on which the first vehicle A travels. The road information is information stored in high accuracy map data stored in the map DB storage apparatus 130, for example. The vehicle condition acquisition unit 12 acquires the road information from the high accuracy map data.

The road information includes road structure information. The road structure information is information of a shape of a road, a shape of a lane, a fork, a junction, an intersection, an entrance and an exit of a tunnel, a place with poor visibility, and the like. The road structure information may include information of a pavement condition of a road. The pavement condition is classified by a railroad crossing, stone pavement, an unpaved road, and the like. The road structure information may include information related to liability to occurrence of vibration. The road structure information may include information of a building causing noise.

The road information may include information of a point where rushing out of a pedestrian and a bicycle is liable to occur. The road information may include information of a point where sudden steering or sudden braking is liable to occur. The road information may include information of a point where a side wind is liable to occur or a point where skidding in rainy weather is liable to occur.

The construction information is information of a road construction, a building construction, and the like carried out around the first vehicle A.

The event information is information of various events held in a facility around the first vehicle A.

The construction information and the event information are acquired from the high accuracy map data appropriately updated by Vehicle Information and Communication System (VICS) (trademark), a dynamic map, and the like, for example. For example, the high accuracy map data stores information of a road construction carried out for a certain period of time, a building construction around a road, and various events. Such a road construction, a building construction, and various events may be performed depending on a season. The construction information and the event information may include information related to occurrence of noise or vibration. When a construction is carried out, for example, the condition of the occupant is liable to worsen, which is caused by occurrence of a steering or braking operation due to passing of a construction vehicle or occurrence of congestion due to the construction itself. When an event is held, for example, the condition of the occupant is liable to worsen, which is caused by occurrence of a steering or braking operation to avoid entry and exit of vehicles or the like from an event site or occurrence of congestion around the event site.

The information collection unit 31 collects the vehicle condition information, in addition to the occupant condition information and the position information, via the communication unit 13 and the communication unit 35. In this case, the vehicle condition information includes at least one type of information of the road information, the construction information, and the event information.

The storage 33 stores the vehicle condition information at the caution points where the condition of the occupant is determined to be abnormal, in association with the caution points.

The information output unit 34 outputs the vehicle condition information associated with the information of the caution points to the second vehicle B, together with the information of the caution points. The information output unit 34 may output the reassurance driving information based on the vehicle condition information to the second vehicle B.

The driving assistance apparatus 200 executes the driving assistance control. The notification apparatus gives notification of the vehicle condition information associated with the caution points. In other words, the notification apparatus gives notification of the road information, the construction information, or the event information at the caution points. The notification apparatus displays the vehicle condition information on the hazard map, for example. The driver of the second vehicle B performs the driving operation, with knowledge of the vehicle condition information that may cause abnormalities in the target occupant at the caution points.

The notification apparatus may display the reassurance driving information at the caution points on the hazard map. The driver of the second vehicle B performs the driving operation, based on the reassurance driving information. The automated driving control apparatus may execute the driving operation based on the reassurance driving information.

### (Fifth Modification of First Embodiment)

The first vehicle A is equipped with a vehicle sensor (not illustrated). The vehicle sensor detects dynamic information of the first vehicle A. The dynamic information is an example of the vehicle condition information indicating the condition of the first vehicle A. The vehicle condition information includes, as the dynamic information, traveling information related to a traveling condition of the first vehicle A, moving object information related to a moving object moving around the first vehicle A, traffic information around a road on which the first vehicle A travels, and weather information around the first vehicle A.

The traveling information includes information of a speed, acceleration (or deceleration), a pitch, a yaw, rolling, and vehicle operations of the first vehicle A, for example.

The moving object information includes information of a pedestrian, a bicycle, and an oncoming vehicle around the first vehicle A, for example. The information of the oncoming vehicle includes information of a car classification.

The traffic information includes information of congestion around the first vehicle A, for example. The traffic information may include information of rushing out of a pedestrian or a bicycle around the first vehicle A. The traffic information may include information of a vehicle with rough driving around the first vehicle A. The rough driving is sudden steering, sudden braking, or the like.

The weather information includes information of precipitation, wind volume, or the like at a point or in a region where the first vehicle A travels. The weather information may include information of a weather condition that imposes a load on the first vehicle A, based on an external factor such as a side wind. The weather information may include information of a weather condition, such as a rainy weather, where skidding is liable to occur.

The vehicle condition acquisition unit 12 acquires the dynamic information detected by the vehicle sensor as the vehicle condition information. The vehicle condition acquisition unit 12 is connected to the vehicle sensor via a local area network (LAN), for example.

The information collection unit 31 collects the vehicle condition information, in addition to the occupant condition information and the position information, via the communication unit 13 and the communication unit 35. In this case, the vehicle condition information includes at least one type of information of the traveling information, the moving object information, the traffic information, and the weather information.

The storage 33 stores the vehicle condition information at the caution points where the condition of the occupant is determined to be abnormal, in association with the caution points.

The information output unit 34 outputs the vehicle condition information associated with the information of the caution points to the second vehicle B, together with the information of the caution points. The information output unit 34 may output the reassurance driving information based on the vehicle condition information to the second vehicle B.

The driving assistance apparatus 200 executes the driving assistance control. The notification apparatus gives notification of the vehicle condition information associated with the caution points. In other words, the notification apparatus gives notification of the traveling information, the moving object information, the traffic information, or the weather information at the caution points. The notification apparatus may display the vehicle condition information or the reassurance driving information on the hazard map, for example. The automated driving control apparatus may execute the driving operation based on the reassurance driving information.

### (Sixth Modification of First Embodiment)

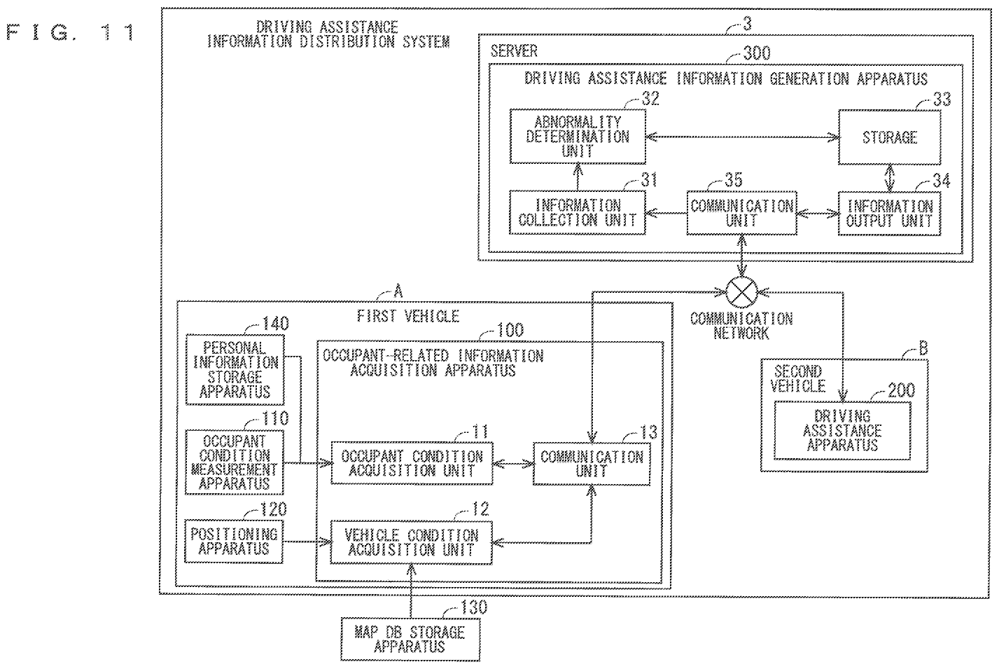

FIG. 11 is a functional block diagram illustrating a configuration of a driving assistance information distribution system according to a sixth modification of the first embodiment.

The occupant condition acquisition unit 11 acquires chronic disease attribute information of the occupant of the first vehicle A from a personal information storage apparatus 140, and acquires the occupant condition information from the occupant condition measurement apparatus 110. The personal information storage apparatus 140 may be provided in the first vehicle A, or may be carried by the occupant of the first vehicle A. The personal information storage apparatus 140 is, for example, a wearable device, a personal digital assistant, an IC card, or the like. The occupant condition acquisition unit 11 may automatically acquire the chronic disease attribute information, or may acquire the chronic disease attribute information with an operation on the personal information storage apparatus 140 by the occupant. The occupant condition acquisition unit 11 may directly acquire the chronic disease attribute information with an input operation on the occupant-related information acquisition apparatus 100 by the occupant. The chronic disease attribute information is included in occupant personal information.

A chronic disease attribute is, for example, a bone fracture, a heart disease, diabetes, a mental disorder, a physical disorder, or the like. The mental disorder includes a mental disorder of receiving mental pressure due to an ambient environment, such as a closed environment and a road with heavy traffic, for example. The closed environment is inside a tunnel, for example. The road with heavy traffic is a road with many lanes, for example. The physical disorder is a disorder of being irritated by up and down vibration or back and forth and right and left acceleration, for example.

The information collection unit 31 collects the chronic disease attribute information, in addition to the occupant condition information and the position information, via the communication unit 13 and the communication unit 35.

The storage 33 stores the occupant condition information of the occupants for whom it is determined that an abnormality has occurred at the caution points and the chronic disease attribute information, in association with the caution points.

The information output unit 34 outputs the chronic disease attribute information associated with the caution points to the second vehicle B, together with the information of the caution points. The information output unit 34 may output the reassurance driving information based on the chronic disease attribute information to the second vehicle B.

The driving assistance apparatus 200 executes the driving assistance control. The notification apparatus gives notification of the chronic disease attribute information associated with the caution points. The notification apparatus displays the chronic disease attribute at the caution points on the hazard map, for example. The driver of the second vehicle B performs the driving operation, with knowledge of the chronic disease attributes that may cause abnormalities in the target occupant at the caution points.

The driving assistance apparatus 200 may execute the driving assistance control of the second vehicle B, based on information of the caution points associated with the chronic disease attribute matching the chronic disease attribute of the target occupant of the second vehicle B out of the information of the caution points received from the driving assistance information generation apparatus 300. In addition, the driving assistance apparatus 200 may execute the driving assistance control of the second vehicle B, based on the reassurance driving information corresponding to the caution points. The chronic disease attribute information of the target occupant of the second vehicle B is acquired with a method similar to that for the chronic disease attribute information of the occupant of the first vehicle A.

In making a request for information provision for the driving assistance information generation apparatus 300, the driving assistance apparatus 200 may transmit the chronic disease attribute information of the target occupant of the second vehicle B to the driving assistance information generation apparatus 300. The information output unit 34 of the driving assistance information generation apparatus 300 may output information of the caution points associated with the chronic disease attribute matching the chronic disease attribute of the target occupant of the second vehicle B out of the information of the caution points stored in the storage 33 to the driving assistance apparatus 200 of the second vehicle B. In addition, the information output unit 34 may output the reassurance driving information based on the chronic disease attribute information associated with the caution points to the second vehicle B. The driving assistance apparatus 200 executes the driving assistance control of the second vehicle B, based on the information of the caution points and the reassurance driving information.

### (Seventh Modification of First Embodiment)

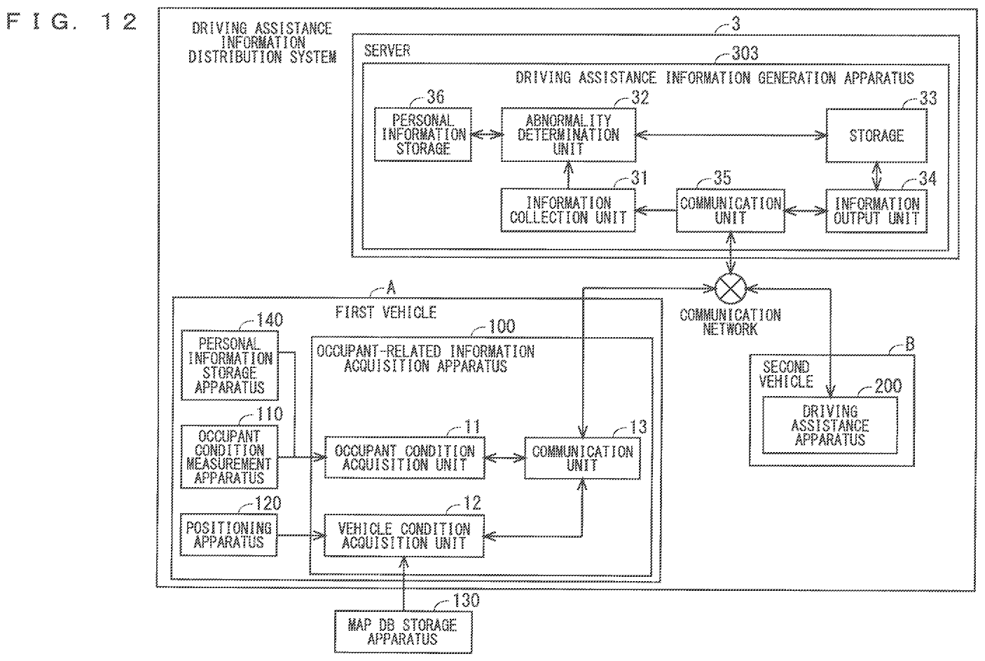

FIG. 12 is a functional block diagram illustrating a configuration of a driving assistance information distribution system according to a seventh modification of the first embodiment. A driving assistance information generation apparatus 303 includes a personal information storage 36, in addition to the configuration of the driving assistance information generation apparatus 300.

The personal information storage 36 stores personal identification information (ID) for identifying each of a plurality of persons and the chronic disease attribute information of each person, in association with each other and in advance. The personal identification information is included in the occupant personal information. The function of the personal information storage 36 is implemented by the processing circuitry illustrated in FIG. 2 or FIG. 3.

The occupant condition acquisition unit 11 acquires occupant identification information (ID) for identifying the occupant of the first vehicle A from the personal information storage apparatus 140. The personal identification information and the occupant identification information have terms being distinguished from each other merely for the sake of description of the embodiment, and can be collated with each other. The occupant identification information is included in the occupant personal information.

The information collection unit 31 collects the occupant identification information, in addition to the occupant condition information and the position information, via the communication unit 13 and the communication unit 35.

When the abnormality determination unit 32 determines that an abnormality has occurred in the condition of the occupant of the first vehicle A, the abnormality determination unit 32 collates the occupant identification information received from the second vehicle B and the personal identification information stored in the personal information storage 36 in advance with each other. The abnormality determination unit 32 reads the chronic disease attribute information associated with the personal identification information matching the occupant identification information out of the chronic disease attribute information stored in the personal information storage 36 in advance.

The storage 33 stores the occupant condition information of the occupant for whom it is determined that an abnormality has occurred at the caution points and the chronic disease attribute information read from the personal information storage 36, in association with the caution points.

### (Eighth Modification of First Embodiment)

The personal information storage 36 stores the personal identification information for identifying each of a plurality of persons, the chronic disease attribute information of each person, and the occupant condition information of each occupant in a normal case, in association with each other and in advance. The chronic disease attribute information is as described above. The occupant condition in a normal case corresponds to a non-abnormal condition, with the occupant staying inside the first vehicle A. The occupant condition in a normal case corresponds to a healthy condition in the vehicle, for example. The occupant condition in a normal case is represented by an attribute value. For example, the occupant condition in a normal case is represented by a numerical value indicating the physical condition in a normal case, a numerical value indicating the physiological condition, or a numerical value indicating the mental condition. The numerical value indicating the physical condition is, for example, coordinates of the occupant, an inclination angle of the body, or the like. The numerical value indicating the physiological condition is, for example, a heart rate, a blood pressure reading, a respiratory rate, or the like. As the attribute value representing the occupant condition in a normal case, a standard value (for example, an average value or the like) may be employed among previous attribute values stored in the personal information storage 36.

The personal identification information, the chronic disease attribute information, and the occupant condition information in a normal case are uploaded from the occupant-related information acquisition apparatus 100 to the driving assistance information generation apparatus 303 in advance, for example. First personal identification information, the chronic disease attribute information, and the numerical value indicating the physiological condition in a normal case may be uploaded from a medical institution such as a hospital. An uploading method is not limited to these.

The occupant condition acquisition unit 11 acquires the occupant identification information for identifying the occupant of the first vehicle A from the personal information storage apparatus 140.

The information collection unit 31 collects the occupant identification information, in addition to the occupant condition information and the position information, via the communication unit 13 and the communication unit 35.

The abnormality determination unit 32 collates the occupant identification information received from the first vehicle A and the personal identification information stored in the personal information storage 36 in advance.

The abnormality determination unit 32 reads the occupant condition information in a normal case associated with the personal identification information matching the occupant identification information from the personal information storage 36. The abnormality determination unit 32 determines whether or not the condition of the occupant is abnormal, based on the occupant condition information collected from the first vehicle A and the occupant condition information read from the personal information storage 36. For example, when the pulse rate of the occupant of the first vehicle A in a normal case is lower than that of a normal person, the abnormality determination unit 32 lowers a threshold of the pulse rate for determining that there is an abnormality in the pulse rate. The abnormality determination unit 32 determines whether or not the condition of the occupant is abnormal, using the adjusted threshold.

Alternatively, the abnormality determination unit 32 reads the occupant condition information in a normal case and the chronic disease attribute information associated with the personal identification information matching the occupant identification information from the personal information storage 36. The abnormality determination unit 32 determines whether or not the condition of the occupant is abnormal, based on the occupant condition information collected from the first vehicle A, the occupant condition information read from the personal information storage 36, and the chronic disease attribute information. For example, depending on an underlying condition of the occupant of the first vehicle A, a threshold of the physiological condition (for example, a threshold of a heart rate, a respiratory rate, or the like) for determining the abnormal condition is adjusted. The abnormality determination unit 32 determines whether or not the condition of the occupant is abnormal, using the adjusted threshold.

The storage 33 stores the occupant condition information of the occupants for whom it is determined that an abnormality has occurred at the caution points and the chronic disease attribute information, in association with the caution points.

### (Ninth Modification of First Embodiment)

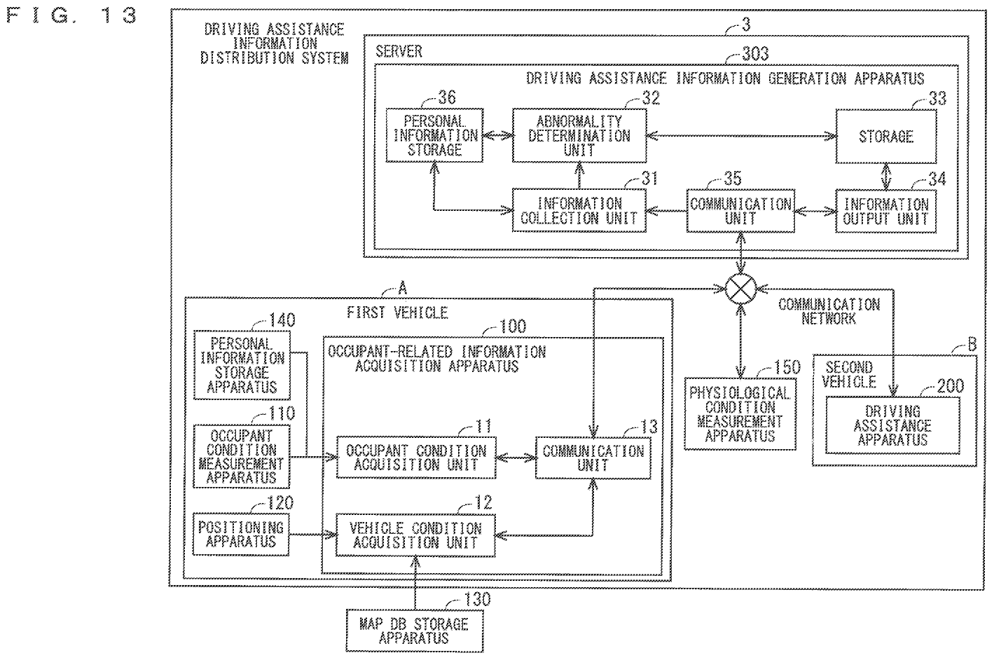

FIG. 13 is a functional block diagram illustrating a configuration of a driving assistance information distribution system according to a ninth modification of the first embodiment.

The personal information storage 36 stores the personal identification information for identifying each of a plurality of persons, the chronic disease attribute information of each person, and the occupant condition information of each person not in the vehicle, in association with each other and in advance. The chronic disease attribute information is as described above. The occupant condition not in the vehicle corresponds to a non-abnormal condition, with the person staying outside the first vehicle A. For example, the physiological condition not in the vehicle is measured by a physiological condition measurement apparatus 150. It is preferable that the physiological condition measurement apparatus 150 be a wearable device, such as a smartwatch. Information of the physiological condition not in the vehicle is uploaded to the driving assistance information generation apparatus 303, and is stored in the personal information storage 36. The occupant condition information not in the vehicle is included in the occupant personal information.

The occupant condition acquisition unit 11 acquires the occupant condition information of the occupant of the first vehicle A in the vehicle from the occupant condition measurement apparatus 110. The occupant condition acquisition unit 11 acquires the occupant identification information for identifying the occupant of the first vehicle A from the personal information storage apparatus 140.

The information collection unit 31 collects the occupant condition information in the vehicle, the position information, and the occupant identification information via the communication unit 13 and the communication unit 35.

The abnormality determination unit 32 collates the occupant identification information received from the first vehicle A and the personal identification information stored in the personal information storage 36 in advance.

The abnormality determination unit 32 reads the occupant condition information not in the vehicle associated with the personal identification information matching the occupant identification information from the personal information storage 36. The abnormality determination unit 32 determines whether or not the condition of the occupant is abnormal, based on the occupant condition information in the vehicle collected from the first vehicle A and the occupant condition information not in the vehicle read from the personal information storage 36.

For example, if the occupant condition in the vehicle has changed from the occupant condition not in the vehicle by a predetermined degree or greater, the abnormality determination unit 32 determines that an abnormality has occurred in the condition of the occupant.

When the symptom of the occupant worsens or recovers, a physiological index of the occupant changes over time. The abnormality determination unit 32 does not detect an abnormality of the occupant based on the physiological index in the vehicle, but determines an abnormality of the occupant based on the physiological index not in the vehicle. This enhances determination accuracy of an abnormal condition by the abnormality determination unit 32.

### (Tenth Modification of First Embodiment)

The driving assistance information generation apparatus 300 may provide the information of the caution points and the reassurance driving information for the second vehicle B, regardless of whether or not a contract for information provision is made.

The driving assistance information generation apparatus 300 may differentiate a type of information and an amount of information to be provided to the second vehicle B, depending on a level of the contract for information provision. For example, the driving assistance information generation apparatus 300 may provide non-subscribers with only the information of the caution points, and provide subscribers with types of abnormalities liable to occur in the occupant, information of occurrences or the like, or the reassurance driving information, in addition to the information of the caution points.

The driving assistance information generation apparatus 300 may regard the first vehicle A as a subscriber. The driving assistance information generation apparatus 300 may regard as a sub-subscriber that can be provided with only a part of information out of the information of the caution points and the reassurance driving information.

### Second Embodiment

A driving assistance apparatus and a driving assistance method according to a second embodiment will be described. In the second embodiment, constituent elements similar to those of the first embodiment or each modification of the first embodiment are denoted by the same reference signs, and detailed description thereof will be omitted.

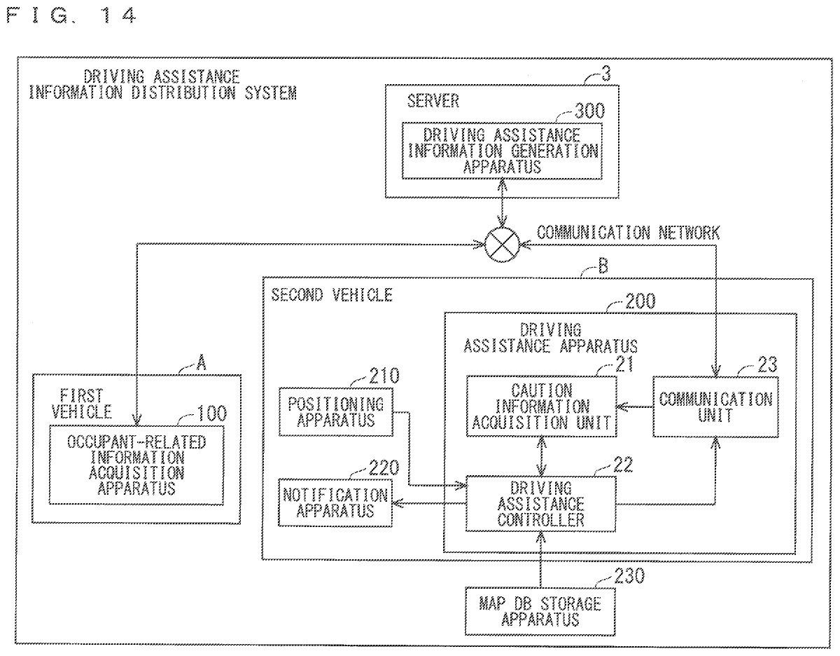

FIG. 14 is a functional block diagram illustrating a configuration of a driving assistance information distribution system according to the second embodiment.

The driving assistance information distribution system includes an occupant-related information acquisition apparatus 100, a driving assistance apparatus 200, a driving assistance information generation apparatus 300, a positioning apparatus 210, a notification apparatus 220, and a map DB storage apparatus 230. Similarly to the first embodiment, the driving assistance information generation apparatus 300 is provided in the server 3, and the occupant-related information acquisition apparatus 100 is provided in the first vehicle A. The driving assistance apparatus 200, the positioning apparatus 210, and the notification apparatus 220 are provided in the second vehicle B. The map DB storage apparatus 230 may be provided in the server 3, or may be provided in the second vehicle B. Configurations of the occupant-related information acquisition apparatus 100 and the driving assistance information generation apparatus 300 are similar to those of the first embodiment or each modification of the first embodiment.

The positioning apparatus 210 detects a position of the second vehicle B. The positioning apparatus 210 includes a GNSS receiver, a vehicle sensor, or the like, for example. The vehicle sensor is a speed sensor, an acceleration sensor, or the like, for example. The positioning apparatus 210 receives positioning data via the GNSS receiver, and detects the position of the second vehicle B, for example. In addition, the positioning apparatus 210 may acquire map data from the map DB storage apparatus 230, and execute map matching. The positioning apparatus 210 may acquire sensor information acquired by various vehicle sensors, and correct position information of the second vehicle B.

The notification apparatus 220 gives notification of the information of the caution points or the reassurance driving information to the driver or the target occupant of the second vehicle B via audio or display. The reassurance driving information includes matters to be paid attention to by the driver of the second vehicle B in regard to the driving operation in a caution area including the caution points. The notification apparatus 220 is, for example, a display apparatus, an audio output apparatus, or the like. In other words, notification contents may be image information, or may be audio information. The display apparatus is not limited to a display, and may be a lamp, an indicator, or the like.

The driving assistance apparatus 200 includes a caution information acquisition unit 21, a driving assistance controller 22, and a communication unit 23.

The caution information acquisition unit 21 acquires the information of the caution points via the communication unit 23. The information of the caution points is information obtained by collecting and recording points where abnormalities have previously occurred in conditions of occupants of the first vehicle A.

The driving assistance controller 22 acquires the position information of the second vehicle B from the positioning apparatus 210. The driving assistance controller 22 controls the notification apparatus 220 so as to give notification of the information of the caution points to the driver or the target occupant of the second vehicle B, based on the position information of the second vehicle B and the information of the caution points.

The driving assistance controller 22 may control the notification apparatus 220 so as to give notification of the reassurance driving information at the caution points to the driver or the target occupant of the second vehicle B. The reassurance driving information may be acquired by the caution information acquisition unit 21 from the driving assistance information generation apparatus 300, or may be created by the driving assistance controller 22 itself. For example, the driving assistance controller 22 acquires information associated with the information of the caution points being stored in the driving assistance information generation apparatus 300, and creates the reassurance driving information based on the information. The information associated with the information of the caution points includes at least one type of information of the vehicle condition information, the occupant condition information, and the chronic disease attribute information, for example.

The communication unit 23 is connected to the driving assistance information generation apparatus 300 via a communication network. The communication unit 23 receives the information of the caution points, the reassurance driving information, and the like.

The driving assistance apparatus 200 includes processing circuitry similar to the processing circuitry illustrated in FIG. 2 or FIG. 3. The functions of the caution information acquisition unit 21, the driving assistance controller 22, and the communication unit 23 are implemented by the processing circuitry of the driving assistance apparatus 200. The same holds true for each modification to be described below.

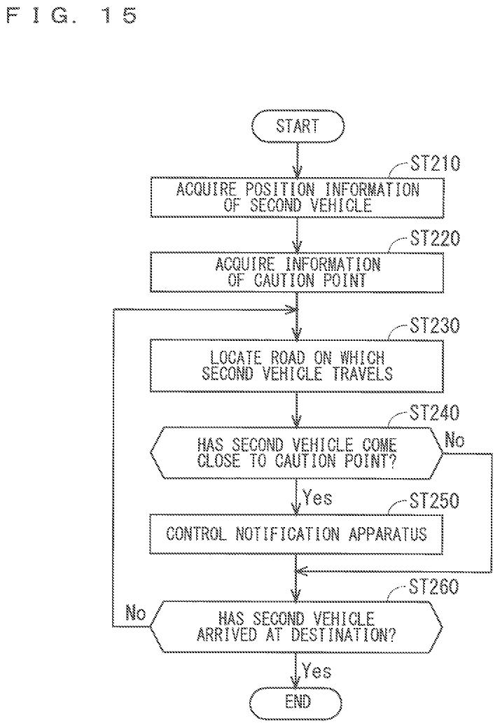

FIG. 15 is a flowchart illustrating a driving assistance method according to the second embodiment. It is preferable that the driving assistance method be executed when there is a target occupant, other than the driver, in the second vehicle B. For example, the second vehicle B is provided with an occupant detection apparatus (not illustrated) that detects the target occupant other than the driver, and it is preferable that only when the occupant detection apparatus detects the target occupant, the driving assistance method be executed. The occupant detection apparatus includes a camera and an image analysis apparatus, for example.

In Step ST210, the driving assistance controller 22 acquires the position information of the second vehicle B from the positioning apparatus 210.

In Step ST220, the caution information acquisition unit 21 acquires the information of the caution points from the driving assistance information generation apparatus 300. For example, the caution information acquisition unit 21 acquires the information of the caution points within a predetermined range, based on the position information of the second vehicle B. The range is a range of 100 km with the position of the second vehicle B being its center, for example. The range may be set to any value by the driver of the second vehicle B. Alternatively, the caution information acquisition unit 21 may acquire the information of the caution points within a range along a route to be travelled that is preset in route search processing. With an acquisition range of the information of the caution points being limited, communication time is reduced in comparison to a case in which the caution points all over the country are collectively downloaded. The caution information acquisition unit 21 may acquire the reassurance driving information in addition to the information of the caution points.

In Step ST230, the driving assistance controller 22 locates a road on which the second vehicle B travels, based on the position information of the second vehicle B and the map data acquired from the map DB storage apparatus 230.

In Step ST240, the driving assistance controller 22 determines whether or not the second vehicle B has come close to a caution point. For example, the driving assistance controller 22 determines whether or not the position of the second vehicle B is within a predetermined distance from the caution point. The distance is 500 m, for example. Alternatively, the driving assistance controller 22 determines whether or not an estimated time period required for the second vehicle B to arrive at the caution point is within a predetermined time period. The time period is 10 minutes, for example. When the notification apparatus 220 executes a plurality of times of notification due to a positional relationship between the second vehicle B and the caution point, a different value is set to the predetermined distance or time period, depending on the number of times of notification.

If it is determined that the second vehicle B has come close to the caution point, Step ST250 is executed. If it is determined that the second vehicle B has not come close to the caution point, Step ST260 is executed.

In Step ST250, the driving assistance controller 22 controls the notification apparatus 220 so as to give notification of the information of the caution points. The driving assistance controller 22 may further control the notification apparatus 220 so as to give notification of the reassurance driving information.

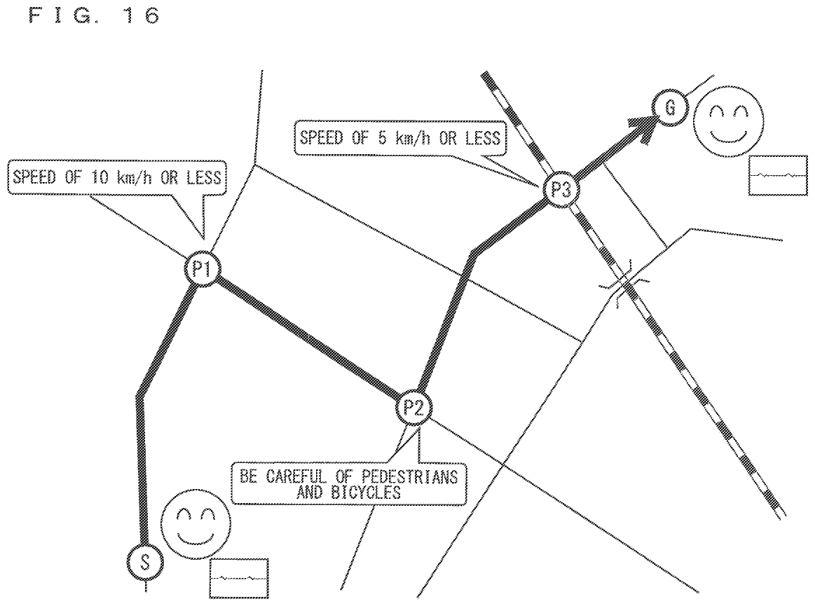

The notification apparatus 220 gives notification of the information of the caution points before the second vehicle B arrives at the caution points, in accordance with the control of the driving assistance controller 22. In addition, the notification apparatus 220 may give notification of the reassurance driving information. FIG. 16 is a diagram illustrating a notification example of the information of the caution points and the reassurance driving information. The information of the caution points and the reassurance driving information are displayed on a map. The map, the information of the caution points, and the reassurance driving information are displayed on a display apparatus provided in the second vehicle B. At the intersection of the point P1, the notification apparatus 220 gives the following notification: “Reduce the speed to 10 km/h or less and change a course well in advance.” At the intersection of the point P2, the notification apparatus 220 gives the following notification: “Make sure first that there are no pedestrians, bicycles, or the like crossing the road, and then make a left turn.” At the railroad crossing of the point P3, the notification apparatus 220 gives the following notification: “There is a level difference in the railroad crossing. Reduce the speed to 5 km/h or less to proceed.”

In Step ST260, the driving assistance controller 22 determines whether or not the second vehicle B has arrived at a destination. If the second vehicle B has not arrived at the destination, Step ST230 is executed again. If the second vehicle B has arrived at the destination, the driving assistance processing ends.

To summarize the above, the driving assistance apparatus 200 according to the second embodiment includes the caution information acquisition unit 21 and the driving assistance controller 22. The caution information acquisition unit 21 is to acquire the information of the caution points from the driving assistance information generation apparatus 300. The driving assistance information generation apparatus 300 stores the information of the caution points. The caution points are each a point where abnormalities have previously occurred in the condition of at least one of the physical condition, the physiological condition, and the mental condition of the occupant, other than the driver, of the first vehicle A being an information collection source. The driving assistance controller 22 is to control the notification apparatus 220 provided in the second vehicle B so as to give notification of the information of the caution points, based on a positional relationship between the position of the second vehicle B being an information providing destination and the caution points.

According to the driving assistance apparatus 200 as described above, the driver of the second vehicle B drives in consideration of the information of the caution points. Such driving operation prevents the target occupant of the second vehicle B from falling into an unstable condition or an uncomfortable condition. The target occupant can move to the destination in the second vehicle B, feeling reassured.

### (First Modification of Second Embodiment)

The driving assistance controller 22 performs control of causing the display apparatus to display all of the caution points and the reassurance driving information in the route to be travelled by the second vehicle B, without determining whether or not the second vehicle B has come close to the caution point. The caution points and the reassurance driving information are displayed in an identifiable display manner. The driving assistance controller 22 may perform control to cause the display apparatus to display a part of the caution points and the reassurance driving information in the route to be travelled.

### (Second Modification of Second Embodiment)

The driving assistance controller 22 controls the notification apparatus 220, based on the traveling information and the vehicle condition information of the second vehicle B. The traveling information includes at least one piece of information of a speed, acceleration, and a driving pattern of the second vehicle B. The vehicle condition information includes at least one type of information of the road information related to a road on which the second vehicle B travels, the construction information around the second vehicle B, and the event information around the second vehicle B.

For example, the driving assistance controller 22 determines whether or not an abnormality is to occur in the condition of the target occupant if the second vehicle B keeps the current speed and enters a caution point, based on the driving pattern of the second vehicle B and the road information of the caution points. When the driving assistance controller 22 determines that an abnormality is to occur in the condition of the target occupant, the driving assistance controller 22 controls the notification apparatus 220.

The notification apparatus 220 gives notification of the information of the caution points and the reassurance driving information, in accordance with the control. The notification apparatus 220 may give notification of a point that may deviate from reassurance driving to the driver of the second vehicle B as the reassurance driving information. The reassurance driving is driving in which an abnormality does not occur in the condition of the target occupant of the second vehicle B.

### (Third Modification of Second Embodiment)

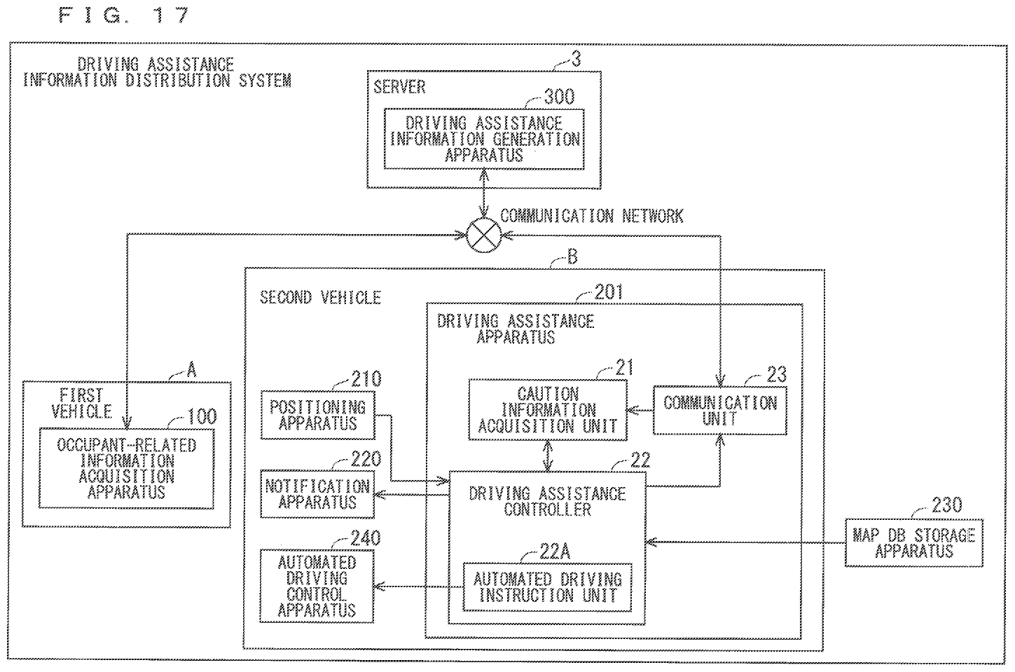

FIG. 17 is a functional block diagram illustrating a configuration of a driving assistance information distribution system according to a third modification of the second embodiment. The second vehicle B is equipped with an automated driving control apparatus 240. The automated driving control apparatus 240 executes automated driving control of the second vehicle B.

The driving assistance controller 22 of a driving assistance apparatus 201 includes an automated driving instruction unit 22A. The automated driving instruction unit 22A outputs an instruction to the automated driving control apparatus 240 to execute the automated driving control.

The automated driving instruction unit 22A outputs the instruction, based on a response of the driver of the second vehicle B to the notification contents of the notification apparatus 220. For example, when the automated driving instruction unit 22A detects that the driver of the second vehicle B does not respond to the reassurance driving information, the automated driving instruction unit 22A outputs an instruction to the automated driving control apparatus 240 to temporarily execute the automated driving control.

The case in which the driver does not respond to the reassurance driving information is a case in which the driver does not perform an avoidance operation when a distance between the second vehicle B and the caution point falls below a predetermined sufficiently-long distance. Alternatively, the case in which the driver does not respond to the reassurance driving information is a case in which the driver does not perform an avoidance operation when an estimated time period required for the second vehicle B to arrive at the caution point falls below a predetermined sufficiently-long time period. The avoidance operation is deceleration, changing a lane, changing a course, or the like.

The automated driving control apparatus 240 intervenes in the driving operation, such as deceleration, for the second vehicle B, in accordance with the instruction of the automated driving instruction unit 22A.

### (Fourth Modification of Second Embodiment)

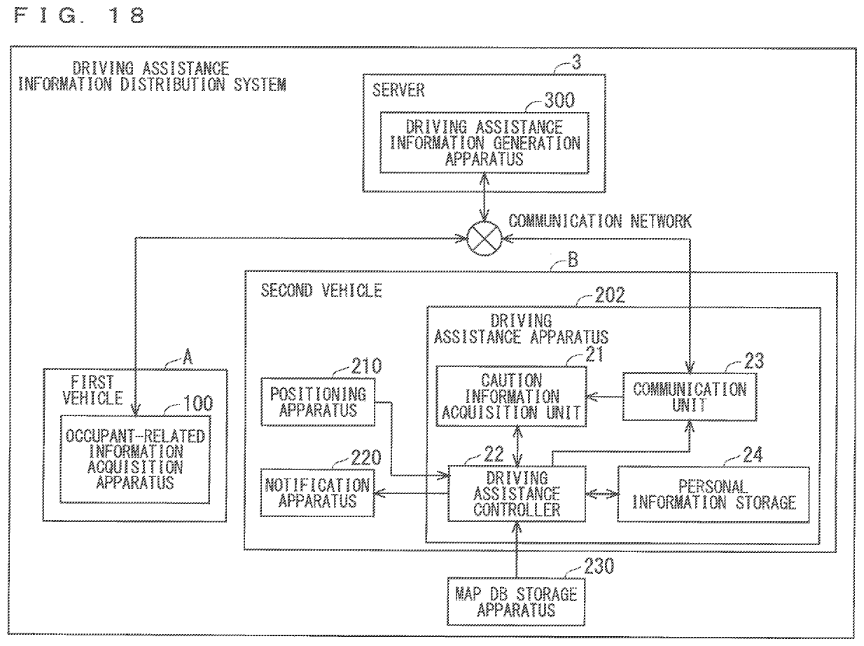

FIG. 18 is a functional block diagram illustrating a configuration of a driving assistance information distribution system according to a fourth modification of the second embodiment. A driving assistance apparatus 202 includes a personal information storage 24, in addition to the configuration of the driving assistance apparatus 200.

The personal information storage 24 stores the chronic disease attribute information of the target occupant of the second vehicle B. The driving assistance apparatus 202 automatically acquires the chronic disease attribute information from a personal information storage apparatus (not illustrated) carried by the target occupant via a communication means, for example. The personal information storage apparatus is a wearable device, a personal digital assistant, an IC card, or the like. The driving assistance apparatus 202 may acquire the chronic disease attribute information of the target occupant via an input operation by the target occupant. The driving assistance apparatus 202 may recognize behaviors and the body of the target occupant through image processing or the like and thereby acquire the chronic disease attribute information. The driving assistance apparatus 202 may acquire the chronic disease attribute information of the target occupant, based on the physiological condition detected by the physiological condition measurement apparatus 150 (see FIG. 13). The driving assistance apparatus 202 may download the chronic disease attribute of the target occupant of the second vehicle B from an external database storing the personal identification information and the chronic disease attribute information of a plurality of persons in association with each other. For example, the driving assistance apparatus 202 downloads the chronic disease attribute information associated with the personal identification information matching the occupant identification information of the target occupant of the second vehicle B.

The caution information acquisition unit 21 acquires the information of the caution points as well as the chronic disease attribute information associated with the caution points from the driving assistance information generation apparatus 300.

The driving assistance controller 22 collates the chronic disease attribute acquired from the driving assistance information generation apparatus 300 and the chronic disease attribute of the target occupant of the second vehicle B.

The driving assistance controller 22 extracts the information of the caution points associated with the chronic disease attribute matching the chronic disease attribute of the target occupant out of the caution points acquired from the driving assistance information generation apparatus 300. The driving assistance controller 22 controls the notification apparatus 220 so as to give notification of the information of the caution points.

In addition, the driving assistance controller 22 performs control to give notification of the reassurance driving information, based on the vehicle condition information, the occupant condition information, or the chronic disease attribute information associated with the caution points. For example, when the chronic disease attribute of the target occupant is a bone fracture, the caution point associated with such a bone fracture attribute is a vibration occurring point. The notification apparatus 220 gives notification of matters to be paid attention to in regard to occurrence of vibration to the driver as the reassurance driving information.

In this manner, the driving assistance controller 22 determines the driving assistance method for the second vehicle B, based on the chronic disease attribute of the target occupant. When a plurality of target occupants of the second vehicle B have chronic disease attributes different from one another, the driving assistance controller 22 performs control so that the reassurance driving information based on the chronic disease attributes of the target occupants are notified. The information of the caution points and the reassurance driving information suited to a specific chronic disease attribute are provided. This enables the driving operation or driving assistance suited to the chronic disease attribute, and reduces a load on the target occupant.

### (Fifth Modification of Second Embodiment)

As the driving assistance method, the driving assistance controller 22 may search for a route having a small number of points to be paid attention to in driving of the second vehicle B, based on the position information of the second vehicle B, the map data, the information of the caution points, and the chronic disease attribute of the target occupant.

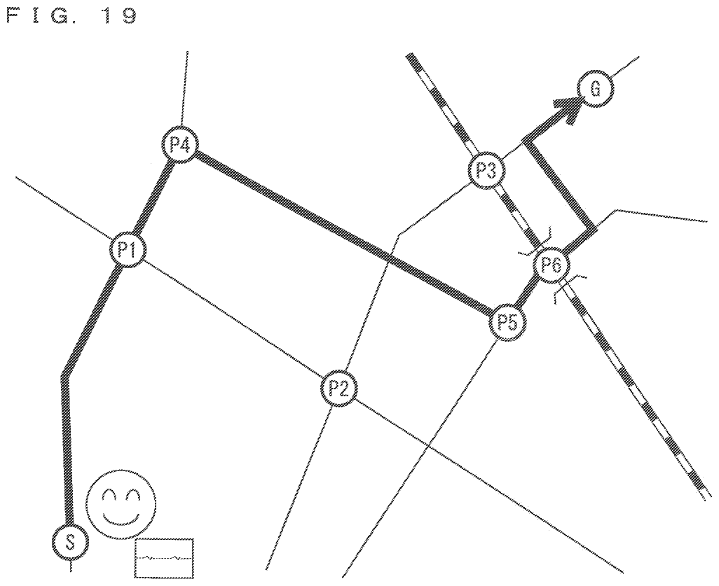

FIG. 19 is a diagram illustrating an example of a route having a small number of points to be paid attention to.

The second vehicle B does not make a right turn at the intersection of the point P1 but travels straight. The second vehicle B makes a right turn at an intersection of a point P4. At the intersection of the point P4, a traffic light dedicated to right-turn vehicles is installed. The second vehicle B can more easily make a right turn at the intersection of the point P4 than the intersection of the point P1.

The second vehicle B does not make a left turn at the intersection of the point P2 but makes a left turn at an intersection of a point P5. At the intersection of the point P5, a pedestrian bridge is installed. The second vehicle B can more easily make a left turn at the intersection of the point P5 than the intersection of the point P2.

The second vehicle B does not cross the railroad crossing of the point P3 but passes through an elevated bridge installed at a point P6.

The second vehicle B traveling on the route having a small number of points to be paid attention to reduces a probability that the condition of the target occupant becomes unstable or the target occupant feels discomfort.

As the driving assistance method, the driving assistance controller 22 may search for a route on which the target occupant can promptly receive aid from a medical institution, based on the position information of the second vehicle B, the map data, the information of the caution points, and the chronic disease attribute of the target occupant. In other words, on an assumption that the condition of the target occupant suddenly changes during traveling of the second vehicle B, the driving assistance controller 22 searches for a route on which aid from a medical institution can be promptly received.

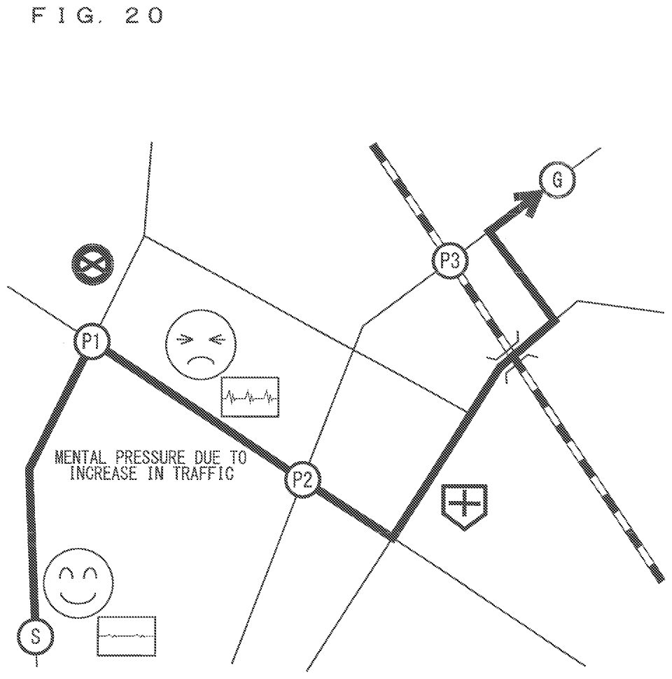

FIG. 20 is a diagram illustrating an example of a route on which aid from a medical institution can be promptly received. Here, the target occupant of the second vehicle B has a mental disorder as a chronic disease.

For example, when the road ahead of the point P1 is closed, the second vehicle B must make a right turn at the intersection of the point P1. When the second vehicle B makes a right turn at the intersection and travels on a road with heavy traffic, the driving assistance controller 22 determines that there is a high probability that the target occupant is to receive mental pressure and an abnormality is to occur in the condition of the target occupant.

The driving assistance controller 22 searches for such a route that the second vehicle B does not make a left turn at the intersection of the point P2 but travels straight to near a medical institution, and presents the route for the driver.

### (Sixth Modification of Second Embodiment)

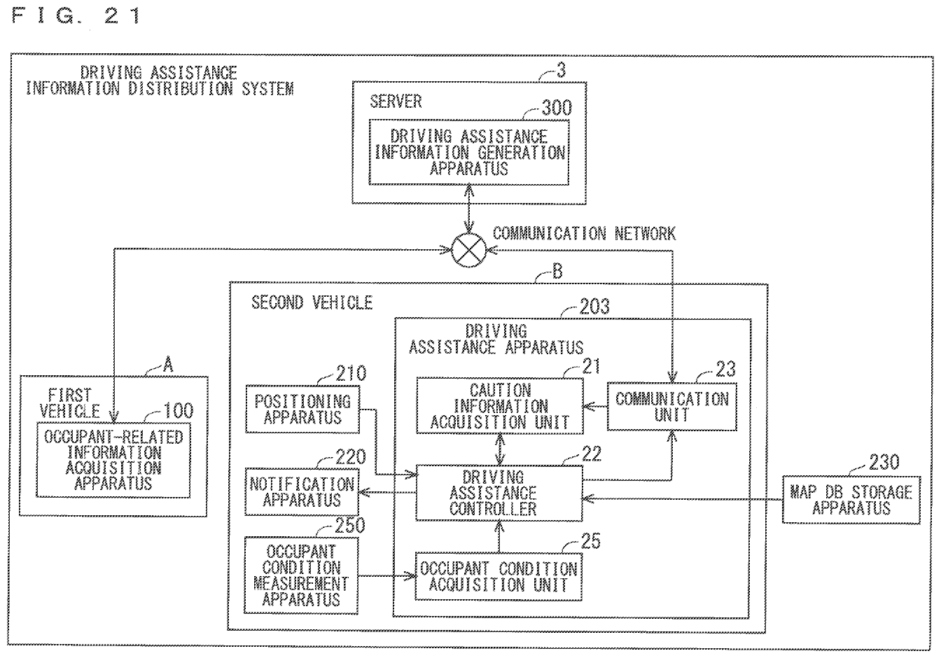

FIG. 21 is a functional block diagram illustrating a configuration of a driving assistance information distribution system according to a sixth modification of the second embodiment. A driving assistance apparatus 203 includes an occupant condition acquisition unit 25, in addition to the configuration of the driving assistance apparatus 200.

The occupant condition measurement apparatus 250 detects the condition of at least one of the physical condition, the physiological condition, and the mental condition of the target occupant of the second vehicle B. The occupant condition measurement apparatus 250 may be provided in the second vehicle B, or may be carried by the target occupant of the second vehicle B.

The occupant condition acquisition unit 25 acquires information related to the condition of the target occupant from the occupant condition measurement apparatus 250.

When the driving assistance controller 22 detects a sign of an abnormality in the condition of the target occupant, the driving assistance controller 22 strictly determines the information of the caution points and gives notification of the reassurance driving information to the driver of the second vehicle B.

### (Seventh Modification of Second Embodiment)

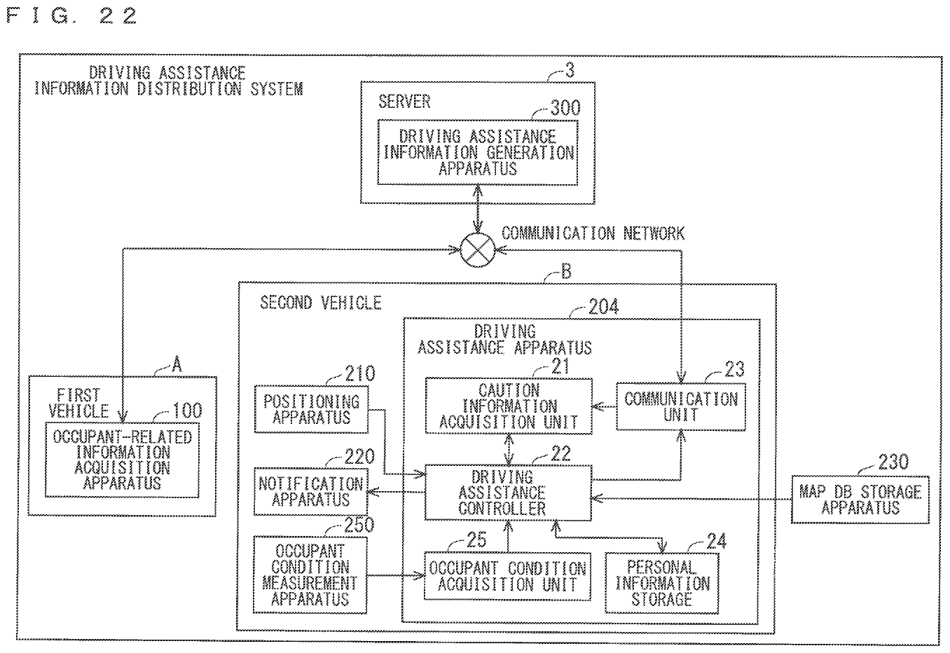

FIG. 22 is a functional block diagram illustrating a configuration of a driving assistance information distribution system according to a seventh modification of the second embodiment. A driving assistance apparatus 204 further includes a personal information storage 24, in addition to the configuration of the driving assistance apparatus 203.

The personal information storage 24 stores information of the condition of the target occupant not in the vehicle in advance. The condition of the target occupant not in the vehicle corresponds to a non-abnormal condition, with the target occupant staying outside the second vehicle B. The condition of the target occupant not in the vehicle is measured by a wearable device, for example.

When the condition of the target occupant in the second vehicle B has changed from the condition of the target occupant not in the second vehicle B by a predetermined degree or greater, the driving assistance controller 22 detects a sign of an abnormality.

### (Eighth Modification of Second Embodiment)

In Step ST220 illustrated in FIG. 15, the acquisition range of the information of the caution points is limited. When the position of the second vehicle B is likely to go beyond the acquisition range, the caution information acquisition unit 21 may download the information of the caution points in a range wider than the acquisition range, i.e., a range including the route to be travelled of the second vehicle B, from the driving assistance information generation apparatus 300.

The driving assistance apparatus 200 may appropriately update the information of the caution points all over the country as in distribution of a map DB in a communication-type car navigation system. In other words, the driving assistance apparatus 200 may download the information of the caution points all over the country from the driving assistance information generation apparatus 300 and store the information, and appropriately check the latest version of a necessary area and update to the latest version. Timing of update processing may be at start of the driving assistance apparatus 200, or may be during traveling of the second vehicle B.

### Third Embodiment

The driving assistance apparatus 200 and the driving assistance information generation apparatus 300 described in the second embodiment and the modifications of the second embodiment can also be applied to a system constructed by appropriately combining a navigation apparatus installed in the vehicle, a communication terminal, the server 3, and functions of applications installed in these. Here, the navigation apparatus includes a portable navigation device (PND) or the like, for example. The communication terminal includes, for example, a mobile terminal such as a mobile phone, a smartphone, and a tablet.

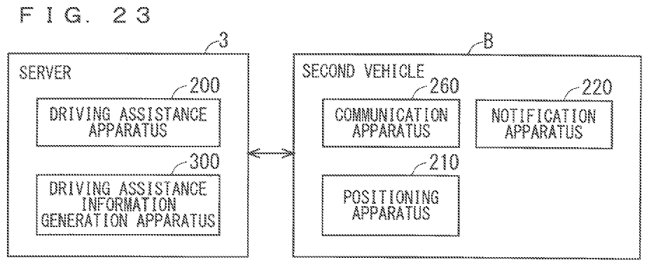

FIG. 23 is a functional block diagram illustrating a configuration of the driving assistance apparatus 200 and the driving assistance information generation apparatus 300 according to a third embodiment.

The driving assistance apparatus 200 and the driving assistance information generation apparatus 300 are provided in the server 3. The driving assistance apparatus 200 acquires the information of the caution points from the driving assistance information generation apparatus 300. The driving assistance apparatus 200 acquires the position information of the second vehicle B from the positioning apparatus 120 provided in the second vehicle B via the communication apparatus 260. The driving assistance apparatus 200 controls the notification apparatus 220 of the second vehicle B, based on a positional relationship between the position of the second vehicle B and the caution points.

In this manner, with the driving assistance apparatus 200 being disposed in the server 3, a configuration of apparatuses provided in the second vehicle B is simplified.

Further, functions or constituent elements of the driving assistance apparatus 200 and the driving assistance information generation apparatus 300 may be disposed in a distributed manner. One example of such a configuration may be a configuration in which a part of the functions or the constituent elements is provided in the server 3 and another part thereof is provided in the second vehicle B.

In the present disclosure, each of the embodiments can be freely combined, and each of the embodiments can be modified or omitted as appropriate.

### EXPLANATION OF REFERENCE SIGNS

3 Server, 11 Occupant condition acquisition unit, 12 Vehicle condition acquisition unit, 13 Communication unit, 21 Caution information acquisition unit, 22 Driving assistance controller, 22A Automated driving instruction unit, 23 Communication unit, 24 Personal information storage, 25 Occupant condition acquisition unit, 31 Information collection unit, 32 Abnormality determination unit, 33 Storage, 34 Information output unit, 35 Communication unit, 36 Personal information storage, 90 Processing circuit, 91 Processor, 92 Memory, 100 Occupant-related information acquisition apparatus, 110 Occupant condition measurement apparatus, 120 Positioning apparatus, 130 Map DB storage apparatus, 140 Personal information storage apparatus, 150 Physiological condition measurement apparatus, 200 to 204 Driving assistance apparatus, 210 Positioning apparatus, 220 Notification apparatus, 230 Map DB storage apparatus, 240 Automated driving control apparatus, 250 Occupant condition measurement apparatus, 260 Communication apparatus, 300 to 304 Driving assistance information generation apparatus, A First vehicle, B Second vehicle, G Destination, P1 Point, P2 Point, P3 Point, P4 Point, P5 Point, P6 Point, S Starting point

1. A driving assistance information generation apparatus comprising processing circuitry to:
collect occupant condition information and position information of a vehicle, the occupant condition information including information related to a condition of at least one of a physical condition, a physiological condition, and a mental condition of an occupant of the vehicle other than a driver, the vehicle being an information collection source;
determine a caution point being a point where an abnormality that affects a body condition of the occupant has occurred in the condition of the occupant, based on the occupant condition information and the position information;
store information of the caution point; and
to output the information of the caution point where the abnormality has previously occurred in the condition of the occupant to a target vehicle, based on a request from outside, the target vehicle being an information providing destination.

2. (canceled)

3. The driving assistance information generation apparatus according to claim 1, wherein
the processing circuit is further to be connected to and to perform communication with a plurality of vehicles via a communication network, the plurality of vehicles each being the information collection source,
the processing circuitry to perform the collection and the determination is provided in each of the plurality of vehicles,
the processing circuitry to perform the storage, the output, and the communication is provided in a server,
in the communication, the processing circuitry is to receive the information of the caution point from each of the plurality of vehicles, and
in the storage, the processing circuitry is to store the information of the caution point received from the plurality of vehicles.

4. The driving assistance information generation apparatus according to claim 1, wherein
the processing circuitry is to store the occupant condition information of the occupant for whom it is determined that the abnormality has occurred at the caution point, in association with the caution point, and
the processing circuitry is to output reassurance driving information to the target vehicle, based on the request, the reassurance driving information being based on the occupant condition information associated with the caution point and including a matter to be paid attention to by a driver of the target vehicle in regard to driving operation in a caution area including the caution point.

5. The driving assistance information generation apparatus according to claim 1, wherein
the processing circuitry is to collect vehicle condition information including at least one type of information of road information related to a road on which the vehicle travels, construction information around the vehicle, the construction information including information related to occurrence of noise or vibration around the vehicle, and event information around the vehicle,
the processing circuitry is to store the vehicle condition information at the caution point, in association with the caution point, and
the processing circuitry is to output reassurance driving information and the vehicle condition information associated with the caution point to the target vehicle, based on the request, the reassurance driving information being based on the vehicle condition information associated with the caution point and including a matter to be paid attention to by a driver of the target vehicle in regard to driving operation in a caution area including the caution point.

6. The driving assistance information generation apparatus according to claim 1, wherein
the processing circuitry is to collect vehicle condition information including at least one type of information of traveling information related to a traveling condition of the vehicle, moving object information related to a moving object moving around the vehicle, traffic information around a road on which the vehicle travels, and weather information around the vehicle,
the processing circuitry is to store the vehicle condition information at the caution point, in association with the caution point, and
the processing circuitry is to output reassurance driving information and the vehicle condition information associated with the caution point to the target vehicle, based on the request, the reassurance driving information being based on the vehicle condition information associated with the caution point and including a matter to be paid attention to by a driver of the target vehicle in regard to driving operation in a caution area including the caution point.

7. The driving assistance information generation apparatus according to claim 1, wherein
the processing circuitry is to collect chronic disease attribute information of the occupant of the vehicle,
the processing circuitry is to store the chronic disease attribute information of the occupant for whom it is determined that the abnormality has occurred at the caution point, in association with the caution point, and
the processing circuitry is to output reassurance driving information or the chronic disease attribute information associated with the caution point to the target vehicle, based on the request, the reassurance driving information being based on the chronic disease attribute information associated with the caution point and including a matter to be paid attention to by a driver of the target vehicle in regard to driving operation in a caution area including the caution point.

8. The driving assistance information generation apparatus according to claim 1, wherein
the processing circuitry is to store personal identification information for identifying each of a plurality of persons and chronic disease attribute information of each of the plurality of persons, in association with each other and in advance,
the processing circuitry is to collect occupant identification information for identifying the occupant of the vehicle, together with the occupant condition information and the position information,
when the processing circuitry determines that the abnormality has occurred in the condition of the occupant at the caution point, the processing circuitry stores, in association with the caution point, the chronic disease attribute information associated with the personal identification information matching the occupant identification information of the occupant out of the chronic disease attribute information stored in the processing circuitry in advance, and
the processing circuitry is to output reassurance driving information or the chronic disease attribute information associated with the caution point to the target vehicle, based on the request, the reassurance driving information being based on the chronic disease attribute information associated with the caution point and including a matter to be paid attention to by a driver of the target vehicle in regard to driving operation in a caution area including the caution point.

9. The driving assistance information generation apparatus according to claim 1, wherein
the processing circuitry is to store personal identification information for identifying each of a plurality of persons and the occupant condition information of the plurality of persons not in the vehicle, in association with each other and in advance,
the processing circuitry is to collect, as the occupant condition information, the occupant condition information of the occupant in the vehicle and occupant identification information for identifying the occupant of the vehicle, and
the processing circuitry is to determine whether or not the abnormality has occurred in the condition of the occupant, based on the occupant condition information not in the vehicle associated with the personal identification information matching the occupant identification information collected from the vehicle out of the occupant condition information not in the vehicle stored in the processing circuitry in advance and the occupant condition information in the vehicle collected from the vehicle.

10. A driving assistance apparatus comprising processing circuitry to:
acquire information of a caution point from a driving assistance information generation apparatus, the driving assistance information generation apparatus to store the information of the caution point being a point where an abnormality that affects a body condition of an occupant has previously occurred in a condition of at least one of a physical condition, a physiological condition, and a mental condition of the occupant of a vehicle other than a driver, the vehicle being an information collection source; and
to control a notification apparatus provided in a target vehicle so as to give notification of the information of the caution point, based on a positional relationship between a position of the target vehicle and the caution point, the target vehicle being an information providing destination.

11. The driving assistance apparatus according to claim 10, wherein
the processing circuitry is to control the notification apparatus so as to give notification of reassurance driving information at the caution point, the reassurance driving information including a matter to be paid attention to by a driver of the target vehicle in regard to driving operation.

12. The driving assistance apparatus according to claim 11, wherein
the processing circuitry is to control the notification apparatus so as to give notification of the reassurance driving information, based on at least one of information of a speed, acceleration, and a driving pattern of the target vehicle and at least one type of information of road information related to a road on which the target vehicle travels, construction information around the target vehicle, and event information around the target vehicle,
the reassurance driving information includes information of a point deviating from reassurance driving, and
the reassurance driving is driving in which the abnormality does not occur in a condition of a target occupant of the target vehicle other than the driver.

13. The driving assistance apparatus according to claim 10, wherein
when the processing circuitry detects that the driver of the target vehicle has not performed reassurance driving within a predetermined zone or within a predetermined time period in response to the notification for prompting the reassurance driving given by the notification apparatus, the processing circuitry outputs an instruction to an automated driving control apparatus to perform automated driving control on the target vehicle to execute the automated driving control, and
the reassurance driving is driving in which the abnormality does not occur in a condition of a target occupant of the target vehicle other than the driver.

14. The driving assistance apparatus according to claim 10, wherein
the processing circuitry is to acquire chronic disease attribute information of the occupant in which the abnormality has occurred at the caution point from the driving assistance information generation apparatus, together with the information of the caution point, the chronic disease attribute information being associated with the caution point, and
the processing circuitry is to determine a driving assistance method for the target vehicle, based on the information of the caution point associated with the chronic disease attribute information matching the chronic disease attribute information of the target occupant.

15. The driving assistance apparatus according to claim 14, wherein
as the driving assistance method, the processing circuitry is to search for a route having a small number of points to be paid attention to in driving of the target vehicle, based on position information of the target vehicle, map data, the information of the caution point, and the chronic disease attribute information of the target occupant.

16. The driving assistance apparatus according to claim 14, wherein
as the driving assistance method, the processing circuitry is to search for a route on which the target occupant can promptly receive aid from a medical institution, based on position information of the target vehicle, map data, the information of the caution point, and the chronic disease attribute information of the target occupant.

17. (canceled)

18. The driving assistance apparatus according to claim 12, wherein
the processing circuitry is to store information of a condition of the target occupant not in the vehicle, and
when a condition of the target occupant in the target vehicle has changed from the condition of the target occupant not in the target vehicle by a predetermined degree or greater, the processing circuitry detects a sign of abnormality in the condition of the occupant in the target vehicle.

19. A driving assistance information generation method comprising:
collecting occupant condition information and position information of a vehicle, the occupant condition information including information related to a condition of at least one of a physical condition, a physiological condition, and a mental condition of an occupant of the vehicle other than a driver, the vehicle being an information collection source;
determining a caution point being a point where an abnormality that affects a body condition of the occupant has occurred in the condition of the occupant, based on the occupant condition information and the position information;
storing information of the caution point; and
outputting the information of the caution point where the abnormality has previously occurred in the condition of the occupant to a target vehicle, based on a request from outside, the target vehicle being an information providing destination.

20. The driving assistance information generation apparatus according to claim 1, wherein
the occupant is a person with a disease, a person receiving care, or a preschool student.

21. The driving assistance information generation apparatus according to claim 1, wherein
the processing circuitry is to store the occupant condition information of the occupant for whom it is determined that the abnormality has occurred at the caution point, in association with the caution point, and
the processing circuitry is to output the occupant condition information associated with the caution point to the target vehicle, based on the request.
